(19) United States
(12) Patent Application Publication
(10) Pub. No.: US 2006/0195433 A1
(43) Pub. Date: Aug. 31, 2006

(54) Information searching system and method thereof

(76) Inventor: Si Han Kim, Kyunggi-Do (KR)

Correspondence Address: NORRIS, MCLAUGHLIN & MARCUS, P.A., 875 THIRD AVE, 18TH FLOOR, NEW YORK, NY, 10022, US

(21) Appl. No.: 11/397,964

(22) Filed: Apr. 3, 2006

Related U.S. Application Data
(63) Continuation of application No. 10/312,518, filed on Dec. 27, 2002, now abandoned.

(30) Foreign Application Priority Data
Jul. 6, 2000 (KR) 2000-38489
Jul. 6, 2000 (KR) 2000-38709
Mar. 6, 2001 (KR) 2001-11565
May 11, 2001 (KR) 2001-25685

(51) Int. Cl. G06F 17/30

(52) U.S. Cl. 707/3

(57) ABSTRACT

In an information searching method, it is first determined if an input retrieval word is a sentence composed of a plurality of words. A functioning code is assigned to each word of the sentence according to its function in the sentence, and then the words are coded in basic words. Then, a database in which information is composed of a sentence having a plurality of words each of which is assigned with a functioning code and coded in a basic word is retrieved on the basis of the coded retrieval word to search information having function codes and word codes identical to those of each word of the retrieval word.

### TECHNICAL FIELD

The present invention relates to an information searching system and method and, more particularly, to an information searching system and method using information concepts.

### BACKGROUND ART

In recent years, information exchange through the Internet has experienced exponential growth. Therefore, a variety of search engines have been developed for quickly and accurately searching information through the Internet has been developed.

However, since all of the prior search engines are designed such that they can search only the information which exactly complies with the word the user inputs, when the user does not know the word complying with the information he wants to find, it is difficult to find the information. Accordingly, there is a need for a search engine capable of finding the information desired by the user precisely and quickly.

### DISCLOSURE OF INVENTION

Therefore, the present invention has been made in an effort to solve the above-described problems of the prior art. It is an objective of the present invention to provide an information searching system and method capable of quickly and accurately searching the information the user desired to find. It is another objective of the present invention to provide an information searching system and method that can quickly and accurately search the information using a search word composed of at least two words.

To achieve the above objective, the present invention provides an information searching system comprising an input part for inputting retrieval words representing information; a database for storing word codes formed by coding words representing the information, each of the word codes being assigned with a functioning code representing its function in the information; and a processor for coding the retrieval words into basic word codes each having a functioning code and retrieving the database on the basis of the basic word codes to search the information having identical functioning and word codes to the basic word codes.

When the retrieval command includes a phrase, each of the words of the command is assigned with the functioning code such that its functions in the command and the phrase can be discriminated from each other.

When the retrieval command is formed of at least two sentences, each of the words of the sentences is assigned with the functioning code such that the sentences can be discriminated from each other.

When there is no information having the identical functioning and word codes, the processor searches information which is identical to the functioning code, and is most similar to the basic word code.

According to another aspect, the present invention provides a method for searching information, comprising the steps of determining if input retrieval command is formed of plural words; coding each of the words into basic word codes with a functioning code; and retrieving a database storing word codes formed by coding words representing the information on the basis of the basic word codes to search the information having identical functioning and word codes to the basic word codes.

The step of retrieving further comprising the steps of selecting information which is most identical to the functioning and word codes of the words of the retrieval command except for a subject word of the retrieval command; and searching information having a word code modified by the selected information and most identical to the subject word.

When there are more than two words having an identical functioning code in the words of the retrieval command, the words having the identical functioning code are grouped and information having the identical functioning code and the most identical word codes is searched.

The step of retrieving further comprises the step of searching information which is identical to a subject word code of the retrieval command and most identical to the rest word codes of the retrieval command.

According to another aspect, the present invention provides a method for searching information comprising the steps of storing word codes of words representing information in a database; coding words of a retrieval command into basic word codes according to a predetermined rule; and searching information which is most identical to the basic word codes by retrieving the database, wherein the word code of the retrieval command is extended to more than two word codes.

When there is a word code of a lower level of the retrieval command not including a retrieval word code, the searching is performing on the basis of a lower level word code not including the retrieval word code.

When the word of the retrieval command is a basic word, the word is coded as a new code formed by basic words describing the word of the retrieval command, and the searching is performed on the basis of the new code.

When coding the words representing the information and the words of the retrieval command, each of the words is coded including a property of the word as a constituting word code.

When there is a word, which is not coded, among the words of the retrieval command, information including the word which is not coded is searched.

According to still another aspect, the present invention provides a method for searching information comprising the steps of storing word codes of words representing information in a database; coding words of a retrieval command into basic word codes according to a predetermined rule; and searching information which is most identical to the basic word codes by retrieving the database, wherein the information to be retrieved is represented as a vector value in a vector space having axe formed by basic word; an angle α between a basic vector and an information vector to be retrieved is calculated, and an indexing database of the information according to the calculated angle is made.

The words of the retrieval command are converted into a vector value, an angle Sα between the basic vector and the retrieval word vector is calculated, and the information is searched on the basis of the calculated angle Sα through the indexing database.

A vector value of the retrieval word according to the functioning code is calculated in the vector space, an angle between the vector value and the basic vector is calculated, and the information is searched considering the functioning code or without considering the functioning code.

If there is a multiple meaning word in the words of the retrieval command or the information to be retrieved, word code sets representing basic word codes constituting word code of the multiple meaning word as other basic word codes are formed, and the word code sets are compared with normal word codes.

According to still another aspect, the present invention provide a work process system comprising a measuring device for measuring a current process condition and outputting data; a process apparatus for performing a process, the process apparatus having a driving device controlled by a control signal so that the process can be realized at an optimum condition; a system controller for detecting a process condition by receiving the data from the measuring device, coding an input word as a word code representing a description of the input word, searching a command word code on the basis of the word code, and transmitting a control signal corresponding to the command word code to the driving device; and a database including a word code database storing word codes representing each process and a command word code database storing command words corresponding to the word codes.

Each of the word code is assigned with a specific process code. The word code includes a data sheet according to the process. The data input by the user is letter or voice data.

The work process system may further comprise a voice/letter converting device.

According to still yet another aspect, the present invention provides a process control method comprising the steps of inputting a command representing a process control; converting the input command into word codes; determining if there is a word code representing a unit process in the converted word codes; assigning a functioning code to the word code representing the unit process; assigning a functioning code to the word code representing the word except for the unit process; searching the word code assigned a functioning code by comparing with the word code list; and selecting the most identical word code to the word code with the functioning code by retrieving a word code list.

According to still yet another aspect, the present invention provides a work process system comprising a client computer having a web browser and a communication device and a web-server, the web-server comprising; an interface part having a data transmission part for connecting to Internet via the communication device and a code conversion part for converting a retrieval command into a retrieval word code; a database having a retrieval word code database storing word codes and a work menu word code database storing word codes representing word menu to output a work menu from the retrieval word code database; and a data process part for comparing the retrieval word code input through the interface part with retrieval word codes of the retrieval word code database and outputting the work menu from the retrieval word codes.

According to yet another aspect, the present invention provides a work process system comprising inputting means for inputting words; a microprocessor for converting the input words into word codes, searching an identical program word codes to the input word codes, selecting a program execution word code matched with the searched program word code, and executing a program corresponding to the selected program execution word code; and a database having program word code database storing word codes corresponding to programs and an execution word code database storing execution words corresponding to the program word codes.

The present invention will be described more in detail with reference to the accompanying drawings.

### BRIEF DESCRIPTION OF DRAWINGS

FIG. 1 is a block diagram of an information searching system according to the present invention;

FIGS. 2a to 2d are flowcharts illustrating an information searching method using functioning codes assigned to word codes;

FIG. 3 is a flowchart illustrating an information searching method using an one logic;

FIGS. 4a and 4b are diagrams illustrating an example of hierarchy of words;

FIG. 5 is a flowchart illustrating a method for expanding word codes of retrieval words;

FIG. 6 is a flowchart illustrating an information searching method using a Vector value in a Vector space;

FIGS. 7a and 7b are flowcharts illustrating an information searching method according to functioning codes in a Vector space;

FIG. 8 is a flowchart illustrating a method for processing a multiple meaning word in a sentence to be converted into word codes;

FIGS. 9a and 9b are control block diagrams of a process system where word codes are applied;

FIGS. 10a and 10b are flowcharts illustrating a process control of a process system where word codes are applied; and

FIG. 11 is a flowchart illustrating a method for operating a website using word codes through the Internet.

### BEST MODE FOR CARRYING OUT THE INVENTION

Preferred embodiments of the present invention will be described more in detail hereinafter.

The present invention provides a concept retrieval method using a meaning of a word.

Generally, the description of a specific word represents the meaning of the specific word. At this point, words used for describing the specific word can be coded according to a predetermined rule. Most of the words may be described by basic words representing the meaning of the words. Such a basic word is coded as a code having the predetermined number of digits to generate a word code of the specific word. Therefore, a word code is that a meaning of the word is arranged as basic word codes.

When it is assumed that basic concepts that can describe words are established and the words are described by the combination of the basic concepts, the basic concepts become the basic words of the present invention. Accordingly, the representation of the words using the combination of the basic word codes becomes word codes, and each of the basic word codes corresponds to one meaning of the word. Table 1 hereinbelow shows a basic word code list used in the present invention.

In the present invention, all of the words representing information are divided into basic words and compound words which are combinations of the basic words. Each of the words is coded as a basic word code to generate a corresponding word code.

According to the above-described rule, all of the information are coded and stored. The retrieval of the information using a word code means that the information is retrieved using a meaning of a word. This can be called as “concept retrieval”.

However, concept retrieval should be applied to a sentence for the natural language retrieval. That is, to use the concept retrieval for the sentence retrieval, the information should be searched in consideration of functions of each word constituting the sentence. Accordingly, a functioning code is assigned to each word so as to be used in retrieving the sentence and the natural language.

The functions of the words in the sentence may be determined through an examining analysis, a morpheme analysis, a meaning analysis by the combination of the words, and a location analysis of the words. This method is performed by a conventional theory of linguistics and the analysis is so called a sentence construction analysis. In addition, an automatic analysis by a program can be realized by a conventional word processor which is made under the functioning analysis theory. Practically, the functioning analysis theory has been used for a translation program and the like

Not all of the words in the sentence should be converted into word codes. It will be sufficient to convert only the noun, adjective, and verb are converted into word codes. That is, when the information is retrieved, it is by far the most effective to retrieve the information using concept retrieval method. Therefore, even when only major words are converted into the word codes, the concept retrieval method can be sufficiently realized.

Generally, one sentence has a corresponding theory, and to complete one theory, a subject, a modifier, a predicate, and an adverb are required. Accordingly, when inputting words to retrieve information, it is very important that which function the input word has. That is, if an input word “k” functions as a major word or a subject word, the input word have to function as the major word or the subject word in the retrieved information. Even when the identical word “k” is searched in the retrieved information, if the word “k” in the retrieved information is a modifier, there will be possibility that the retrieved information is not the desired information. Accordingly, the word having an identical function should be searched.

The present invention provides an information searching method on the basis of one logic constituting a sentence through the functioning codes. To this end, each of the words constituting the sentence is assigned with a functioning code, and the information is retrieved on the basis of the functioning code. If there are functioning codes such as “S(subject)”, “V(predicative)”, “A(modifier)”, and “P(adverbial phrase)”, one logic can be formed using the four functioning codes. Accordingly, when the information is retrieved, the words are first coded in consideration of the function of the constituting elements of the one logic.

When the information is retrieved using word codes, the number of digits of the constituting word codes of the word code is predetermined so that the search comparison can be easily realized in the program. For example, when the word codes is “nmamkpo-fstelolor”, all of the basic word codes are designed having two digits such as “ma, mk, po, -f, st, el, ol, or” except for the “n” which represents a part of speech “noun”.

In addition, in the word codes, a location of the constituting word codes are also predetermined so that the most identical information can be easily searched. That is, a basic word code functioning as a modifier is located right next the main constituting word code, and a word code functioning as an adverb is located following the “-”.

For example, when a word “valve” can be illustrated, “in a medical field (me), as an organ (og) for controlling (co) the flow (fl) of blood (bl) in (-i) the heart (ha)”, it can be coded as a word code “menog=coblfl-ha”. In this word code, a code “=”, is assigned before a verb or a predicate so as to discriminate the verb and the predicate from other words.

In the above, the word code is composed of constituting word cords. There are a main constituting word code which is a basic word code functioning as a subject in the word code, and a sub-constituting word code which is the rest basic word code except for the main constituting word code. For example, in the word code “menog=coblfl-ha”, a main constituting word code is “og”, a sub-constituting word code is “coblfl-ha”, and a constituting word code is “og=coblfl-ha”.

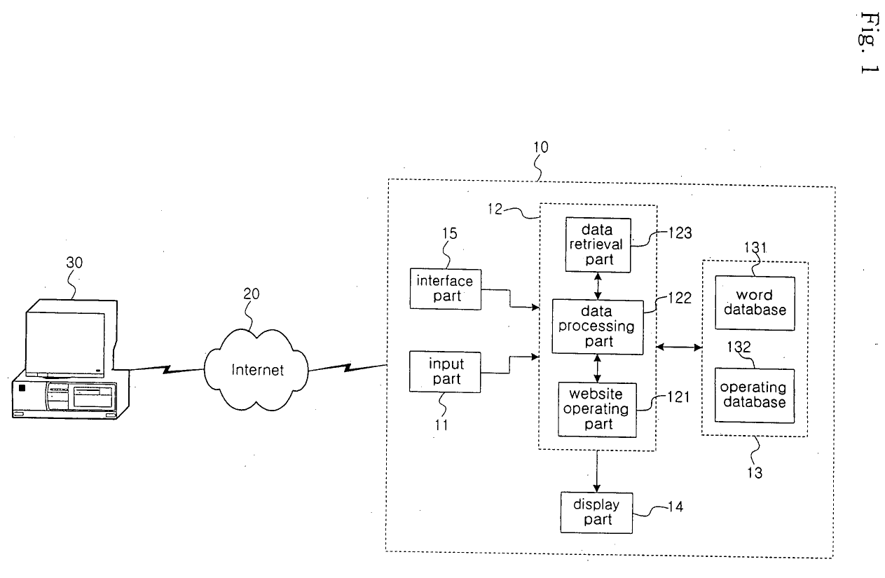

FIG. 1 shows an information searching system according to a preferred embodiment of the present invention. The information searching system (referring as “information retrieval server” hereinafter) of the present invention comprises an input part 11 for inputting a word or a sentence corresponding to the information to be searched, a central process unit 12 for dividing the word or sentence input through the input part 11 into basic words, coding the same, and searching the desired information on the basis of the coded word, a database 13 for storing a plurality of information which is subdivided into and codes as basic words, and a display 14 for displaying retrieval command input through the input part 11 and the retrieval results processed by the central process unit 12.

As shown in FIG. 1, the information retrieval server 10 is connected to a network (wire and wireless network, a future network and the like) such as Internet 20. That is, the information retrieval server 10 is connected to an outer information input system 30 through the Internet 20. Therefore, the information retrieval server 10 further comprises an interface part 15 for receiving and transmitting data from and to the outer information input system 30 according to the control of the central process unit 12.

The information retrieval server 10 constructs the database 13 by dividing and coding the plurality of information according to the predetermined rule and retrieves the information corresponding to a retrieval command input through the input part 11 or a retrieval command input from the outer information input system 30 through the interface part 15 on the basis of the database 13. The results of the retrieval is transmitted to the user's information input system 30 or displayed on the display part 14.

The database 13 of the information retrieval server 10 comprises an operating database 132 for storing data required for operating the Internet site and the system and a word database 131 in which divided and coded basic words of the information are stored.

The central process unit 12 comprises a site operating part 121 for operating the website and system on the basis of the stored data in the operating database 132, a data processing part 122 for dividing the information input through the input part 11 into basic words, coding the basic word and storing the basic word codes in the word database 131, and dividing and coding the retrieval command input through the input part 11 or the interface part 15, and a data retrieval part 123 for searching the information corresponding to the retrieval data by retrieving the word database 131 on the basis of the retrieval command processed by the data processing part 122.

As the information input system 30 that can connect with the information retrieval server 10, a computer and a communication system for connecting the computer to the Internet can be used.

A method for coding the word or sentence constituting the information by the above-described information searching system will be described hereinafter. Here, the coding of the word or sentence is meant by a coding of the stored information or the retrieval command. The coding method of the present invention is applied to both the retrieval command and the stored information.

For example, in a sentence “in 2000s, an engine technology is more related to the electronics”, when major words are coded, this sentence can be coded as “in 2000s, an engine(nmamkpo-fstelolor) technology(nkn-iscinan) is more related (vbc) to the electronics(nel)”. That is, the subject of the sentence is “technology”, the modifier is “engine”, and the predicate is “electronics”. At this point, when the functioning code of the subject is “S”, the functioning code of the modifier is “A”, the functioning code of the predicate is “V”, and the functioning code of the adverb representing the time or era is “P”, the functioning codes can be assigned to the corresponding words. Here, the word “engine” can be represented as “machinery(ma) making (mk) power(po) from(-f) steam(st), electricity(el), or(or) oil(ol)) and the like”. When major words are selected and coded, this can be coded as “nmamkpo-fstelolor”. The “n” indicates that the word “engine” is a noun. A code “ma” of the main constituting word is located following the code representing the part of speech. Following the code “ma”, a word code functioning as a modifier “mk” is located, following of which the word “power” code “po” is located, and a basic word code “fstelolor” functioning as an adverbial phrase is located after the code “-”. Each word is represented as two digits code. The code “or” located at the tail of the code represents that the codes “stelol” are combined each other in the logical add relationship.

In addition, the word “technology” can be represented as “knowledge(kn) in the science(sc) and(an) the industry(in)”. Therefore, this can be coded as “nkn-iscinan” according to the above described coding rule. That is, the code “n” represents that the word “technology” is noun, and the code “an” at the tail of the code represents that the code “scin” are combined each other in the logical product relationship.

In the above word code, when function codes are assigned to each code, this can be represented as “in 2000s(nyrP), the engine(nmamkpo-fstelolorA) technology(nkn-iscinanS) is(vbcV) more related to the electronics(nelV)”.

In addition, when a sentence representing information is “Clinton, the president(npr) of the United States is living(vli) with very busy in the White House(nhoofpr-ius)”, the “Clinton” is a proper noun(C), the “president” is a subject (S), the “in” is an adverb(P) representing a place, the “living” is a predicate(V), and the “United States” is an adverb(P) representing a place. Accordingly, the above sentence can be coded as “usP Clinton(C) nprS nhoofpr-iusP vliV”.

As described above, when a sentence is coded, only major words are selected, coded, and assigned with a functioning code. In addition, a variety of symbols such as a period can be used as it is so that the sentences can be easily discriminated.

For reference, since Clinton is a proper noun, a code “C” representing the proper noun is assigned to the proper noun. Alternatively, a word code having a meaning “the xxth president of the United States” may be assigned or a code representing Clinton itself may be assigned.

A adverb representing a place or a time may be determined according to the word. For example, “America” and “White House” are adverbs representing a place, and “year 2000” and “2 O'clock” are adverbs representing a time. In addition, since a word may have an adverb meaning as well as a declension of a modifier, a variety of retrieving method should be used. Therefore, a variety of retrieval algorithm are proposed by the present invention.

Generally, a retrieval word can be represented by one or more sentence having a phrase and/or a clause. When the number of sentence is more than two, it is required to discriminate the sentences. For example, when there is a word functioning as an adjective, it should be defined if the adjective is a word for modifying the subject of the whole sentence or a word for modifying a word functioning as a subject of the phrase.

For example, in a sentence “a car(nca) engine(nmamkpo-fstelolor) technology(nkn-iscinan) is started(st) for the first time(fi) in the United States (nus) during(nti-obeenan) the First Word War(nwawofi)”, a code representing the function in the sentence may be assigned to each word.

For example, the word “technology” has a main constituting word code “kn” and a sub-constituting word code “sc, in”. Therefore, the constituting word code of the word “technology” becomes “kn, sc, in”.

In addition, the word code of the First Word War becomes “nwa(war) wo(world)fi(the first)”, and the word “during” can be represented as “time(ti) of(-o) a beginning(be) and(an) an end(en)”, and thereby coded as “nti-obeenan”. Although “United States” is an adverbial phrase representing a place and “the First World War” is a modifier functioning as an adjective, they do not modify the subject word “technology” of the whole sentence, but modify the subject word “United States” of the adverbial phrase. Therefore, functioning codes assigned to a word modifying the subject of the sentence and a word modifying a adverbial phrase should be discriminated.

Accordingly, when the functioning codes are assigned to the word codes of the sentence, the above sentence can be codes as “a car(ncaa) engine (nmamkpo-fstelolorA) technology(nkn-iscinanS) is started(nstV) for the first time (nfiVA) in the United States(nusP) during(nti-obeenanPA) the First Word War (nwawofiPA)”.

In the above code, all of the functioning codes are written in a capital letter, and the functioning code of a word modifying “United States” is represented as “PA”. That is, the code “PA” means that this word modifies “United States” which is a main word in an adverbial phrase representing a place. Accordingly, when the sentence is illustrated in a word code, the word code becomes “nwawofiPA nti-obeenanPA nusP ncaa nmamkpo-fstelolorA nkn-iscinanS nfiVA nstv”.

In addition, the word code of “for the first time(nfi)” becomes “nfiVA” since it modifies(A) the word “started” which is the predicate(V).

There may be a complex sentence which is formed of two sentences. For example, a sentence “Clinton, the president(npr) of the United States is living(vii) with very busy(dbu) in the White House(nhoofpr-ius), and Hillery is busy(abu) in New York” is composed of two sentences. In a word code of “busy”, the “a” is a code for representing that the word “busy” is an adjective and the “d” is a code for representing that the word “with busy” is an adverb.

When a functioning code is assigned to the complex sentence, it is required to define where each of the functioning code is included. Therefore, when the functioning code is assigned to each word code in the above complex sentence, the sentence can be represented as “Clinton(CA), the president of the United States(nprS) is living(vliV) with very busy(dbuVA) in the White House (nhoofpr-iusP), and his wife Hillery(CS1) is busy(abuV1) in New York(CP1)”. Then the sentence is converted into a word code “Clinton(CA), nprS vliV dbuVA nhoofpr-iusP, CS1 abuV1 CP1”. Since the complex sentence includes two sentences and “.” are used in the word code.

In the first sentence, the word “president” functions as a subject, it is assigned with a functioning code “S”, and the word “living” functions as a predicative, it is assigned with a functioning code “V”. However, in the second sentence, the word “Hillery” functions as a subject and it is assigned with a functioning code “S1” to be discriminated with the subject of the first sentence, and the word “busy” functions as a predicative and it is assigned with a functioning code “V1” to be discriminated with the modifier of the first sentence. Likewise, when the sentence is composed of 3 or 4 sentences, the Arabic numerals “2” and “3” are assigned behind the functioning code so as to discriminate the sentences.

As described above, it is possible to discriminate that which words the modifier and the predicate are connected to. Accordingly, it is possible that the information can be retrieved on the basis of the concept representing the whole sentence.

A method for retrieving information on the basis of a database in which a plurality of information is coded according to the present invention will be described hereinafter.

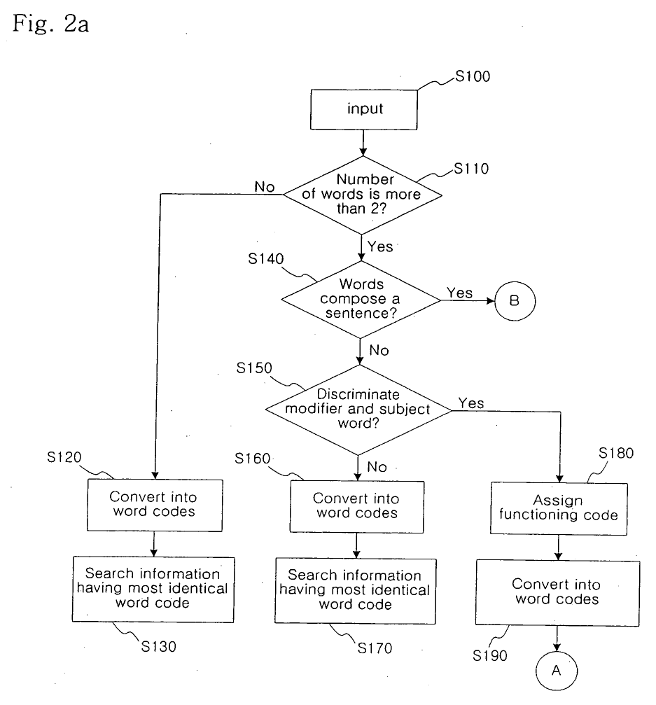

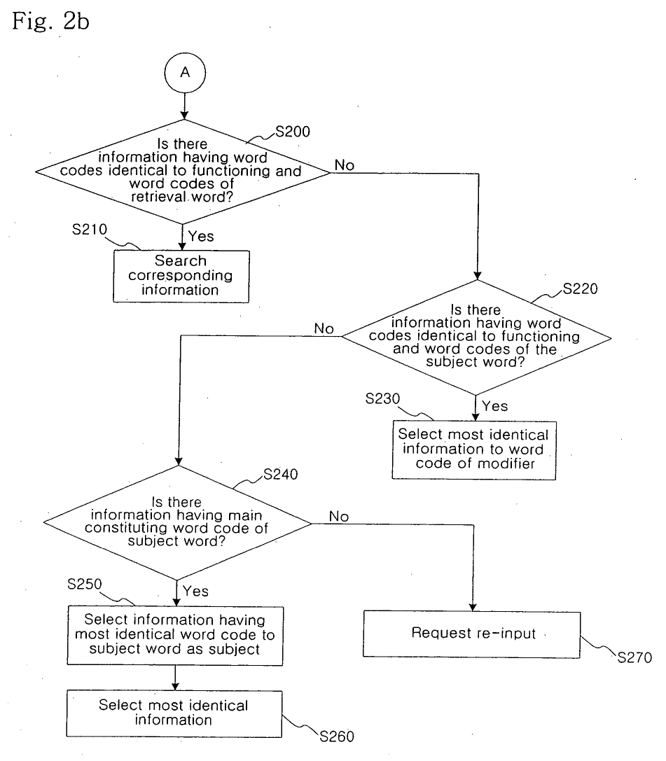

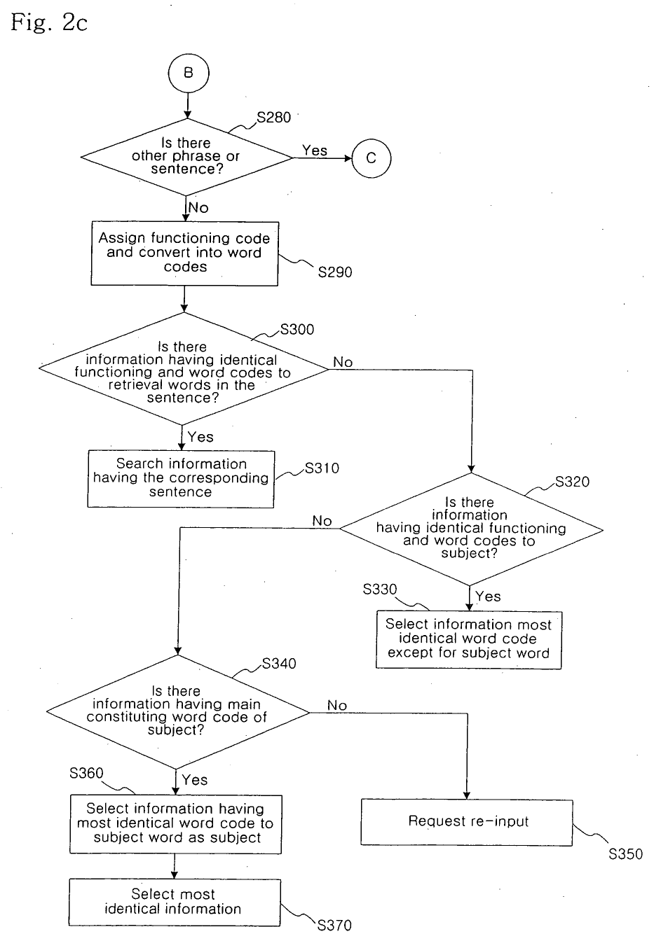

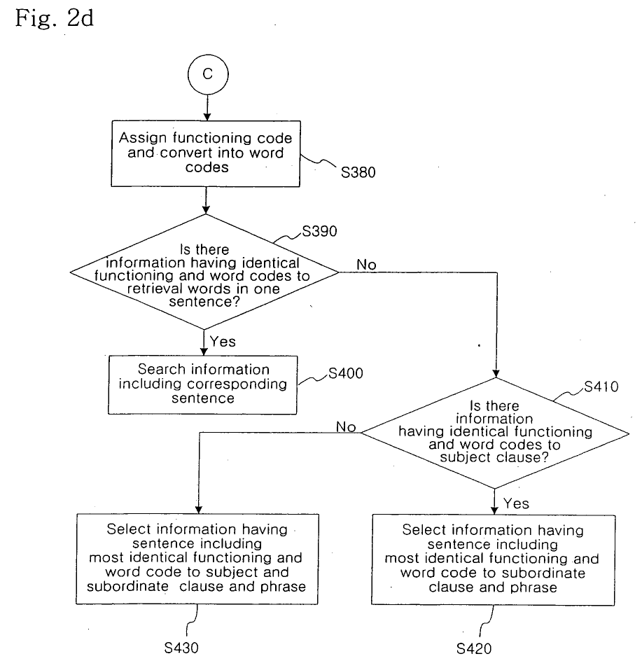

FIGS. 2a to 2d shows a flowchart illustrating an information searching method using the functioning code assigned to the word code according to the first embodiment.

As shown in FIG. 2a, when a retrieval command is input through the input part 11 or the interface part 15, the data process part 122 of the central process unit 12 determines if the number of input word is more than two (S100-S110). When the number of input word is one, the data process part 122 converts the retrieval command into a corresponding word code and the data retrieval part 123 retrieves the word database 131 on the basis of the word code to search the corresponding information.

At this point, when the retrieval command has more than two meanings, it may be optional to allow the user to select one of the meanings which can be displayed on an interactive window. In addition, when the retrieval command is basic word and represented with more than two word codes, the word codes are retrieved by or-logic. For example, when the retrieval command is “cold” which is a basic word, it can be coded as “cl”. Since the word “cold” has a meaning “a temperature(te) lower(lo) than(t) an usual states(us)”. Accordingly, it can be also coded as “atelo-tus”. That is, the word “cold” may be coded into two word codes such as “cl” and “atelo-tus” both of which can be used for searching the information(S120-S130).

When the number of input word is more than two, it is determined if the retrieval commands are a sentence (S140). When the retrieval command is not the sentence, it is determined if the retrieval commands can be discriminated into a subject word and a modifier (S150).

For example, when the retrieval commands are “engine(nmamkpo-fstelolorA) technology(nkn-iscinanS)”, although these two words can be analyzed using or-logic, it will be better to use and-logic. Accordingly, the word “engine” can be a modifier modifying the word “technology” which is a subject word.

For some words, it is difficult to discriminate the subject word and the modifier. For example, when the retrieval commands “sports car, medium car, compact car or diesel car”, the retrieval commands are simply arranged in parallel and they cannot be discriminated into the subject word and the modifier. That is, if the retrieval commands are an identical type (i.e., an identical part of speech), each word of the retrieval commands has the parallel relationship.

As described above, when it is difficult to discriminate the retrieval commands into the subject word and the modifier, these are coded according to the above-described coding rule. When the retrieval commands are coded as word codes, the information having the identical word code or the most identical word code is searched in the word database 131 (S160-S170).

In S150, when the subject word and the modifier is discriminated, the data process part 122 assign the functioning code “A” to the modifier “engine”, and assign the functioning code “S” to the subject word “technology”. The data retrieval part 123 retrieves the word database 131 on the basis of the coded word to search the corresponding information as described hereinafter.

As shown FIG. 2b, it is first determined if there is information having a code identical to functioning and word codes of the retrieval commands. For example, when the retrieval commands is “the United States(nusS) during(nti-obeenanA) the First World War (nwawofiA)”, this can be codes as “nwawofiA nti-obeenana nusS” with the functioning codes.

At this point, the information having a code identical to the functioning and word codes of the retrieval commands means a sentence or a phrase including a word code “nwawofi” with a functioning code “A”, a word code “nti-obeenan” with a functioning code “A”, and a word code “nus” with a functioning code “S”. Namely, when information includes only one or two of the functioning and word codes, the information is not the correct information corresponding to the retrieval commands. That is, information including all of the functioning and word codes “nwawofiA nti-obeenanA nusS” are searched, and the searched information is displayed on the display part 14 (S200-S210).

In S200, when there is no corresponding information, information having a word identical to functioning and word codes of the subject word in the retrieval commands is searched (S220). That is, when the word code of the retrieval commands is “nwawofiA nti-obeenanA nusS”, information having a sentence with a word code “nusS” corresponding to the subject word is selected.

In the selected information, sub-information having the largest number of codes identical to a word code of the modifier of the retrieval commands is selected (S230). That is, when the retrieval word code is “nwawofiA nti-obeenanA nusS”, information having the most identical code to the modifying word code “nwawofiA nti-obeenanA” is selected. Here, the most identical code means information including a word having the word code “nus” with the functioning code “S” and a modifier having the most identical code to the code “nwawofi” or “nti-obeenan”.

In S220, when there is no information including a word code and a functioning code that are identical to those of the subject word code of the retrieval command, information having an identical main constituting word code to the subject word of the retrieval command and having a functioning code of the subject word is searched (240). When the information is searched, the subject word and the modifier are selected in one sentence. The constituting word code of the selected word are compared with the constituting word code of the retrieval commands, and the most identical information is searched(S250-S260).

For example, when the retrieval word code is “engine(nmamkpo-fstelolorA) technology(nkn-iscinanS)”, the main constituting word code becomes “kn”. Accordingly, information having the most identical word code to the sub-constituting word code (except for the main constituting word code) “mamkpo-fstelolor, scinan” is searched. By this procedure, a sentence or a phrase including the identical main constituting word code and the most identical sub-constituting word code can be selected.

Alternatively, when the retrieval word code is “nwawofiA nti-obeenanA nusS”, since the word code of the subject word is formed of the main constituting word code, the rest word code except for the subject word becomes a word code “nwawofiA nti-obbenanA”. Therefore, a sentence or a phrase including a word having the most identical constituting word code to “wawofi ti-obbenan” is selected.

In addition, when there is no information having the main constituting word code which are identical to the subject word of the retrieval commands and a functioning code of the subject word, the user is requested to input a new retrieval command through the display part 14 (S270).

In S140, when the input retrieval command is composed of more than two words making a sentence, the search process goes to a process as shown in FIG. 2c. First, the data process part 122 determines if there is other sentence or phrase (S280). When there is no other sentence or phrase, major words such as an adjective, a noun and a verb are selected and assigned with a corresponding functioning code. And the major words are converted into word codes (S290). Next, a sentence having functioning and word codes identical to those of the retrieval command is searched (S300). For example, when the retrieval command is “car technology started in the United States”, and if the major words are selected and coded with a functioning code, the retrieval command can be coded as “nusP ncaa nmamkpo-fstelolorA nkn-iscinanS stV”.

After the retrieval command is coded, the word database 131 is retrieved to search information including a word code and a functioning code identical to the retrieval word code and display the searched information on the display part 14 (S310).

In S300, when there is no identical sentence, information including a word having a word code and a functioning code that are identical to those of the subject word of the retrieval command (S320). That is, a sentence including a word having a word code and a functioning code that are identical to the subject word code “nkn-isinanS” of the retrieval command is selected. When the sentence is selected, information having a word code that is most identical to the rest word code “nusP ncaA nmamkpo-fstelolorA stV” of the retrieval command is selected(S330).

In S320, when there is no information including the word having a word code and a functioning code that are identical to those of the subject word of the retrieval command, a phrase or sentence including a subject word having a word code identical to a main constituting word code of the subject word of the retrieval command is searched(S340).

When there is no corresponding information, the user is requested to input a new retrieval command (S350).

After the information including a sentence having a subject word with a word code identical to the main constituting word code of the subject word of the retrieval command is selected, sub-information having a subject word with a code which is most identical to the subject word code of the retrieval command is selected(S360). That is, information having a word code which is most identical to the subject word code “nkn-iscinanS” of the retrieval command is searched. The most identical word code means that it includes a word code identical to the corresponding word code of the retrieval command or has the most identical word code to the constituting word code of the corresponding word code.

When comparing the constituting word codes, a word code being most identical to a basic word code and a functioning code in the word code is assigned with the priority. That is, for the word code “nkn-iscinanS”, a word having the basic word code “sc” in an adverbial phrase(-i) is assigned with the priority.

When the sentence is selected according to the above-described process, information which is most identical to the retrieval command is selected in the selected sentence(S370). That is, a word which is most identical to the retrieval word code “nusP ncaa nmamkpo-fstelolorA stV” is searched and displayed.

Here, in the process of searching the most identical information, the information can be searched in a state where the sub-constituting word code of the subject word of the retrieval command can be specially classified. For example, when the retrieval command is “engine(nmamkpo-fstelolorA) technology (nkn-iscinanS)”, the information may be searched in a state where a functioning code “A” may be assigned to the sub-constituting word code “scinan” except for the main constituting word code “kn” in the word code “nkn-iscinanS”. In this case, the retrieval word code is converted into “nmamko-fstelolorA scinanA nknS” when the information is searched.

In addition, only the functioning code assigned to the subject word of the retrieval command can be considered when the information searched. That is, other functioning codes are not considered but only the constituting word codes are considered. For example, when the retrieval command is “nus nca nmamkpo-fstelolor nkn-iscinan st”, only the functioning code “S” which should be assigned to the word code “nkn-iscinan” is considered during the search process of the information. Other functioning codes for other word codes are not considered, but the constituting word codes of them are considered.

In S280, when the retrieval command is composed of more than two sentences or phrases, the search process goes to routine as shown in FIG. 2d.

First, the data process 122 part assigns a functioning code to the corresponding major word codes such as a noun, adjective, and verb(S380). When the sentence has more than two sentences or phrases, the identical part of speech in the sentences or phrases should be discriminated by being assigned with a discriminating functioning code.

For example, when the retrieval command is “the car engine technology started in the United States during the First world war”, it can be coded as “ncaa nkmamkpo-fstelolorA nkn-iscinanS stV nusP nti-obeenanPA nwawofiPA”. That is, since the words “First World War” and “during” modifies the word “United States”, the functioning codes of them should be discriminated from the word modifying the word “technology” which is the subject word of the sentence.

The data process part 122 searches information having functioning and word codes which are identical to those of the retrieval command, and further searches sub-information having the corresponding sentence which is identical to those of the retrieval command in the information(S390-S400).

When there is no corresponding sentence in the information, other information having functioning and word codes identical to those of the subject clause of the retrieval command is searched(S410). That is, since the phrase “car(ncaA) engine(nmamkpo-fstelolorA) technology(nkn-iscinanS) started(stV)” can be the subject clause, information having the functioning and word codes identical to those of the subject clause is searched, after which information having a code which is most identical to the rest code except for the code of the subject clause of the retrieval command is searched (S420).

When there is no information identical to the subject clause of the retrieval command, information having functioning and word codes which are most identical to those of the subject clause, subordinate clause, phrase and the like of the retrieval command is searched(S430). This searching method is performed under the flowchart shown in FIG. 2c.

An information searching method according to a second embodiment of the present invention will be described hereinafter. The information searching method of this second embodiment is conducted by one logic. That is, the one logic has one concept composed of some of the subject, modifier, descriptive word, and an adverbial phrase. Accordingly, when the retrieval command is composed of one logic, the search is performed by the logic.

It is not important that the logic to be searched is existed as the subject, modifier, or an adverbial phrase. That is, the retrieval command may be the information to be searched if it has the logic in spite of its location.

For example, when the retrieval command is “the United States(nus) during(nti-obeenan) the First World War(nwawofi)”, although the retrieval command is not the perfect sentence, it has the subject word and the modifier, making one logic. At this point, the logic can be existed in information to be searched as a subject word or a modifier.

For example, a logic “the United States during the First World War” can be used in a variety of sentences such as “the car technology was developed in the United States during the First World War”, and “although the car technology was developed in the United States during the First World War, the United States was very unsettled during the First World War”. An information searching method for this case is very important.

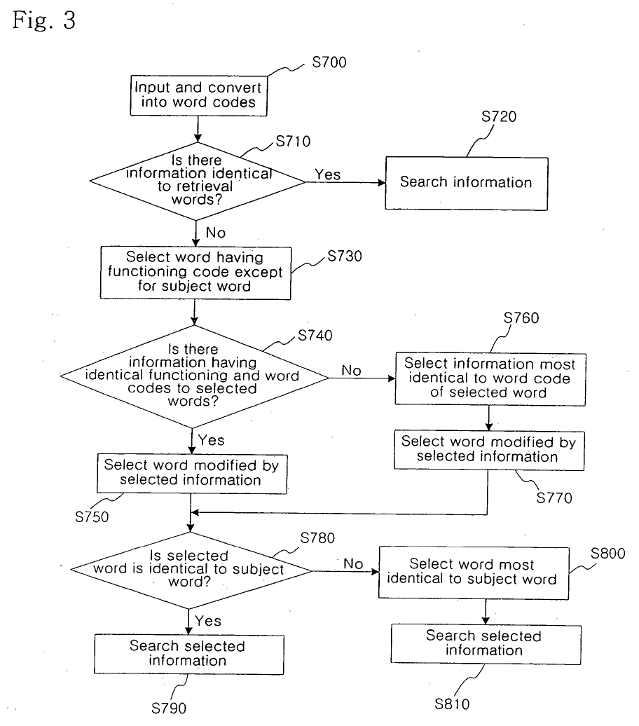

FIG. 3 shows a flowchart illustrating an information searching method by one logic according to a second embodiment of the present invention. When a retrieval command is input, the data process part 122 converts the retrieval command into a word code assigned with a functioning code (S700) and searches information having a word code and a functioning code which are identical to those of the retrieval command (S710-S720).

When there is no identical information, the rest words except for the subject word in the retrieval command are selected (S730), and it is determined if there is an identical information to the selected word. When there is an identical information, a word which is modified by the identical information is selected (S740-S750).

When there is no identical information to the rest words except for the subject word, information having the most identical to the word code of the rest word is selected (S760-S770). That is, information which is most identical to the rest words except for the subject word in the retrieval command is selected.

Next, in S750 or S770, a word modified by the selected word is compared with the subject word of the retrieval command (S780). Accordingly, when information having the word modified by the selected word and being identical to the subject word of the retrieval command (S780) or having the selected word most identical to the subject word of the retrieval command becomes the final information (810). For example, when the retrieval command is “the United States(nus) during(nti-obeenan) the First World War(nwawofi)”, this can be coded as “nwawofiA nti-obeenanA nusS”. At this point, in the information to be retrieved, the information search object is to search information which has identical word code and functioning code or is most identical. However, since the functioning code may be located in a variety of positions in the sentence, information which is most identical to the functioning and word codes of the word code “nwawofiA nti-obeenanA” except for the subject word of the retrieval word is first searched, and information having the word code “nus” is then searched without considering the functioning code of “nus”.

Accordingly, if the retrieval word code is “nwawofiA nti-obeenanA nusS”, when information is searched according to the algorithm shown in FIG. 3, a plurality of information having a word code such as “nwawofiA nti-obeenanA nusp”, “nwawofiA nti-obeenanA nusA”, “nwawofiA nti-obeenanA nusV” and the like is searched. That is, the searched information has an identical functioning code to the modifier of the retrieval command but has a different functioning code from the subject word of the retrieval command.

There may be more than two words having an identical functioning code in the retrieval command. In this case, it is determined if there are more than two words having an identical functioning code, and when there are more than two, these two words are combined as one word code. That is, when more than two words have an identical functioning code, these words are considered as one word. For example, when the retrieval word code is “nwawofiA nti-obeenanA nusS”, there are two words having an functioning code “A”. Accordingly, information is searched by combining the two words using or-logic concept. That is, information having the functioning code “A” and the word code “nwawofiA nti-obeenanA” or information having a code which is most identical to the word code “nwawofiA nti-obeenanA” is searched.

Although the constituting word codes contained in the word of “nwawofi nti-obeenan” in the retrieval word code is divided into two words each having the functioning code “A”, the information can be searched in the stored information as far as it has the functioning code “A” even when the constituting word code is divided into more than two words.

This approach can be identically applied when the retrieval command is a sentence. That is, when the retrieval command is “nusP ncaa nmamkpo-fstelolorA nkn-iscinanS stV”, the words are classified according to the functioning codes. The words each having an identical functioning code are grouped and information having an identical word and functioning codes or having a code which is most identical to the constituting word code is searched.

In addition, the ranking of a plurality of searched information is very important. That is, it will be convenient for the user to enumerate the plurality of searched information in the order to the identicalness to the retrieval command.

Therefore, in the present invention, a different weight for the identicalness is assigned to the plurality of searched information, the plurality of searched information are arranged in the order of the weight value. For example, information exactly identical to the retrieval word code is assigned with a weight value higher than that assigned to information including a code identical to the retrieval word code. In addition, the weight value of the main constituting word code is higher than that of the sub-constituting word code. The weight value of the subject word is higher than that of the other words.

For example, when the retrieval word code is “nmswtptor(letter)”, the weight value of the main constituting word code “ms” is higher than that of the sub-constituting word codes “wt, pt, or”. In addition, when the retrieval word code is “car(ncaa) engine(nmamkpo-fstelolorA) technology(nkn-iscinanS)”, the subject word code “nkn-iscinanS” has an higher weight value than that of the rest word codes “ncaa nmamkpo-fstelolorA”.

As described above, in the word code “nmswtptor”, when the word code “ms” is assigned with a weight value of 50, each of the rest word code “wt, pt, or” is assigned with a weight value of 50/3. Likewise, in the word code “ncaa nmamkpo-fstelolorA nkn-iscinanS”, the word code “nkn-iscinanS” is assigned with a weight value of 50, and each of the rest word codes “ncaA nmamkpo-fstelolorA” is assigned with a weight value of 50/2.

If the retrieval word code is “ncaa nmamkpo-fstelolorA nkn-iscinanS”, when the weight value of information exactly identical to the retrieval word code is 100, a weight value of searched information “nusP ncaa nmamkpo-fstelolorA nkn-iscinanS” is less than 100. That is, since another word code “nusP” is added, the searched information is assigned with less weight value.

A method for expanding the retrieval command will be described hereinafter according to a third embodiment of the present invention.

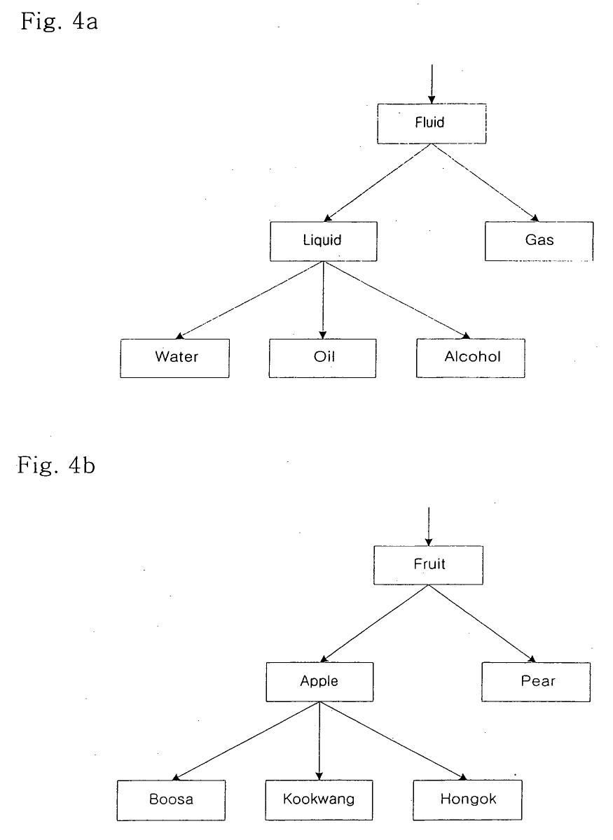

FIG. 4a shows an example of a hierarchy of words. The hierarchy in the linguistics means that words are classified and arranged from a higher concept to a lower concept. The classification is realized in the form of tree diagram such that the classified words extend from an identical branch. That is, words located in the identical level and extended from an identical branch become a similar word.

As shown in FIG. 4a, the words “liquid” and “gas” are branched off from an identical branch and located at the identical level, they becomes a similar word. Likewise, the words “water”, “oil” and “alcohol” becomes a similar word.

A generic character of a word in making a word code will be described hereinafter. A generic character of a word is a characteristic of the word. When the words are classified in the form of the hierarchy, a word contained in the higher level can be the generic character of a word contained in the lower level. That is, as shown in FIG. 4a, the generic character of the words “liquid” and “gas” becomes a word “fluid”, and the generic character of the words “water”, “oil” and “alcohol” becomes a word “liquid”.

Accordingly, it would be better to add a code representing the generic character of the word to the word code to be made. As shown in FIG. 4b, since a generic character of a word “pear” is a word “fruit”, the word code representing the word “fruit” should be included in a word code of the word “pear” as a constituting word code. That is, since the word “pear” can be represented as “a sweet(st) fruit(ft) produced by a plant(pn)”, the word “pear” can be coded as “ftstpn”. Needless to say, since the word “pear” is a word representing a special name, the word can be used for retrieving information without being coded.

In addition, since the word “water” is a basic word, this can be coded as a basic word code “wr”. Accordingly, for the basic word, a code representing the generic character of the water cannot be added to the word code of the water.

That is, when the retrieval command is a basic word, this basic word is coded by using other words describing the meaning of the basic word, and the generic character code is added to the coded basic word. For example, the word “water” can be represented as “liquid(lq) composing(co) the creature(ct), sea(sa) and river(rv)”. Therefore, the word code of the water can be “lq=coctsarv” including the generic character code “lq” as a constituting word code.

That is, when the information to be retrieved or the retrieval command is coded as a basic word code, the generic character code is added to the basic word code as a constituting word code.

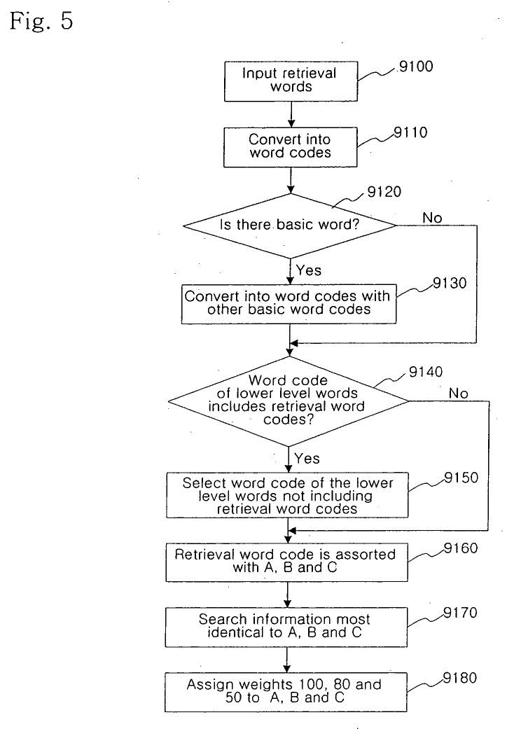

FIG. 5 shows a method for expanding a word code of a retrieval command according to a fourth embodiment of the present invention.

The retrieval command can be a single word or a sentence composed of more than two words. The concept of the retrieval command in the present invention includes a retrieval command for searching information and a program commander such as a word or a sentence for inputting information through a computer.

When the retrieval command is input through the information input system 30 or an input part 11, the retrieval command is coded as a word code through the central process unit 12 and the database 13 and it is determined if there is a basic word in the retrieval command (S9100-S9120).

When there is a basic word in the retrieval command, the word code of the retrieval command is converted into a word code composed of other basic word codes describing the basic word (S9130). For example, when there is a word “water” in the retrieval command, since the water is a basic word, the word code of the water is converted into a word code “lq=coctsarv” which is formed of other basic word codes describing the word “water”.

The Step 9130 is also used when the retrieval command is used to search the information without being coded as a word code. For example, when there is a word “Clinton” in the retrieval command, since the word “Clinton” is a special word, the retrieval command can be used to search the information without being coded “Clinton” or can be converted into a word code formed of basic words describing the word “Clinton”.

Next, in the hierarchy of the words, it is determined if there is a word having a retrieval word code which is not included in a word code of a lower level word of the retrieval command, and then a word code of the lower level word not having the retrieval word code is selected (S9140-S9150).

For example, when the retrieval command includes a word “liquid”, the lower level word of the word “liquid” includes “water”, “oil” and “alcohol”. However, all of these words are basic words, the word code of the water becomes “wr”, the word code of the oil “ol”, and the word code of the alcohol “ac”. In these word codes, there is no word code of the word “liquid” as a constituting word code. Accordingly, when there is a word “liquid” in the retrieval command, the word codes of the words “water”, “oil” and “alchole” are selected.

Noun may a word which does not include a constituting word code of the retrieval word code. For example, when the retrieval command includes a word “apple”, the lower level word includes “Kookwang”, “Hongok” and “Busa”. Since these words are a proper noun, these are used to search the information without being coded as word code. Accordingly, when the retrieval command includes a word “apple”, the words “Kookwang”, “Hongok” and “Busa” may be selected.

When a retrieval word code is “A”, a retrieval word code represented by other basic word codes is “B”, and a word code selected from the lower level of the retrieval command is “C”, a variety of information which is most identical to the word codes “A”, “B” and “C” are searched in order(S9160-S9170).

Next, the searched results are assigned with different priorities by assigning different weight values according to the following three retrieval results (S9180).

For example, when the retrieval command is “water(wr) quantity(qa, material, mt, contained, cn) in apple(al)”, it can be coded as “alP wrA qamt=cnS”. When this code is “A”, the information can be searched by using this code “A”.

In addition, when there is a basic word in the retrieval command, the basic word can be converted into a word code representing another basic word. That is, the code “wr” can be converted into “Iq=coctsarv”. And the “al” into “ftccrd skjcfs(fruit circle red skin, juicy flesh)”. Accordingly, the retrieval word code becomes “frccrdskjcfsp lq=coctsarvA qamt=cnS”. When this code is “B”, the information can be searched by using this code “B”.

In addition, since the lower level of the “apple” becomes “Busa”, “Hongok” and “Kookwang” and these words may be used to search information without being coded, the word code of the retrieval command is not included in these word as a constituting word code. Accordingly, when the retrieval command is “apple”, the words “Busa”, “Hongok” and “Kookwang” are selected and coded. That is, there may be three codes such as “Busa(C)P wrA qamt=cnS”, “Kookwang(C)P wrA qamt=cns” and “Hongok(C)P wrA qamt=cnS”. Therefore, when these word codes are “C”, the information may be searched by using these word codes “C”. In these codes, the “(C)” is a symbol representing that a special noun which is used as it is without being coded.

As described above, the information may be searched by using the A, B and C, and the searched information may be assigned with a different weight value.

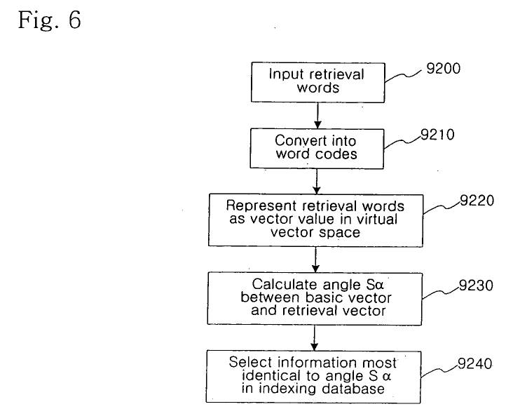

A method for searching information using a vector space according to a fifth embodiment of the present invention. FIG. 6 shows a flowchart illustrating a method for searching information using a Vector value in the Vector space.

Since the word codes are formed of basic word codes, when the basic word codes are denoted as a Vector axis, the word or information can be represented as a vector value in the vector space. In addition, the information to be retrieved can also be represented as a vector value in the vector space. An indexing database can be made on the basis of the vector values in the vector space.

To make the indexing database, basic vector is first established. The basic vector is virtual information having a single basic word. That is, when it is assumed that the number of basic word is 1400, the basic vector has only one of the basic words. This can be illustrated as a coordinate as follows:

(1, 1), (2, 1), (3, 1), (4, 1), (5, 1), (6, 1), (7, 1), (8, 1) . . . (1395, 1), (1396, 1), (1397, 1), (1398, 1), (1400, 1)

The first numeral in the parenthesis indicates an order of the axis of the coordinates, and the second numeral in the parenthesis becomes a scale of the axis of the coordinate. In addition, all of the variety of information to be retrieved are assigned with their addresses and represented as vector values in the vector space.

For example, in certain information “A”, when a use frequency of a 1st basic word is “0”, a scale of a first axis in the virtual vector space having 1400 axe becomes “0”. In addition, when a use frequency of a 20^{th} basic word is “5”, the scale of the 20^{th} axis becomes “5”. Likewise, when the u se frequencies of the 30^{th} and 1300^{th} are respectively “12” and “3”, a value of the information “A” can be established in the vector space. That is, the location of the information A can be represented as follows:

(1, 0), . . . (20, 5), . . . (25, 0), . . . (30, 12), . . . (1200, 0), . . . (1300, 3), . . . (1400, 0)

By representing the information as a vector value, an angle between the basic vector and the vector of the information A can be calculated. A formula for calculating the angle is as follows:
|a||b| cos α=a·b (1)
where, |a| indicates an absolute value of the vector “a”, |b| indicates an absolute value of the vector “b”, and “a b” indicates a dot vector of the “a” and “b” vectors. In the formula (1), cos α can be calculated, and the α which is an angle between the vectors “a” and “b” can be calculated. As the value of the α is reduced, the distance between the vectors “a” and “b” is drawn near and two information becomes more similar.

By the above described principle, the plurality of information can be arranged in the order of the value “α”. That is, the database can be made by arranging the addresses of the plurality of information to be retrieved in the order of the value “α” as follows:

$$\begin{matrix}0.01 ° \text{:} xxxxxxxx , xxxxxxxx , xxxxxxxxxx , xxxxxxxxxx , ⋯ \\ 0.02 ° \text{:} xxxxxxxx , xxxxxxxx , xxxxxxxxxx , xxxxxxxxxx , xxxxxxx ⋯ \\ 0.03 ° \text{:} xxxxxxxx , xxxxxxxx , xxxxxxxxxx , xxxxxxxxxx , xxxxxxxx ⋯ \\ 0.04 ° \text{:} xxxxxxxx , xxxxxxxx , xxxxxxxxxx , xxxxxxxxxx , xxxxxxxxx ⋯ \\ 0.05 ° \text{:} xxxxxxxx , xxxxxxxx , xxxxxxxxxx , xxxxxxxxxx , xxxxxx , ⋯ \\ \begin{matrix}⋮ \\ 10.01 ° : xxxxxxxx , xxxxxxxx , xxxxxxxxxx , xxxxxxxxxx , xxxxxx , ⋯ \\ 10.02 ° : xxxxxxxx , xxxxxxxx , xxxxxxxxxx , xxxxxxxxxx , xxxxxx , ⋯ \\ 10.03 ° : xxxxxxxx , xxxxxxxx , xxxxxxxxxx , xxxxxxxxxx , xxxxxx , ⋯ \\ 10.04 ° : xxxxxxxx , xxxxxxxx , xxxxxxxxxx , xxxxxxxxxx , xxxxxx , ⋯\end{matrix}\end{matrix}$$

As described above, the indexing database can be made in a states where the plurality of information to be retrieved are arranged in the order of the value “α” and the information can be searched on the basis of this indexing database. Here, the “xxxxxxxx” represents symbolically the address of the corresponding information.

When a retrieval command is input, the retrieval command is converted into a word code, and the retrieval command is represented as a vector value in the virtual vector space in which basic words are represented as axe (S9200-S9220). Next, an angle Sα between a basic vector and a retrieval command vector in the vector space is calculated (S9230). In addition, in an indexing database of the plurality of information to be retrieved, one information having an angle which is identical to the angle Sα or most similar to the same is selected (S9240). The most similar angle is an angle difference less than 0.03°. When it is assumed that the angle between the retrieval command vector and the basic vector is 10°, the information to be searched becomes information having an angle of 10±0.030’. Needless to say, if there is no information having an angle difference less than 0.03°, other information having an angle different higher than 0.03° is selected.

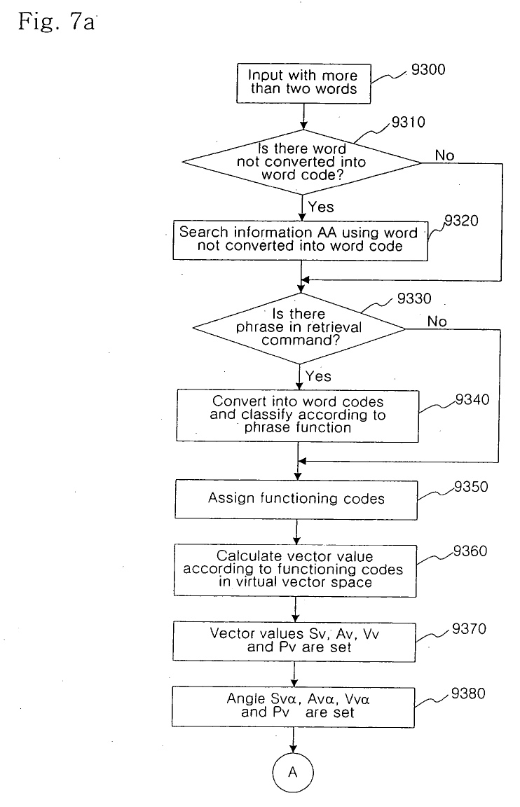

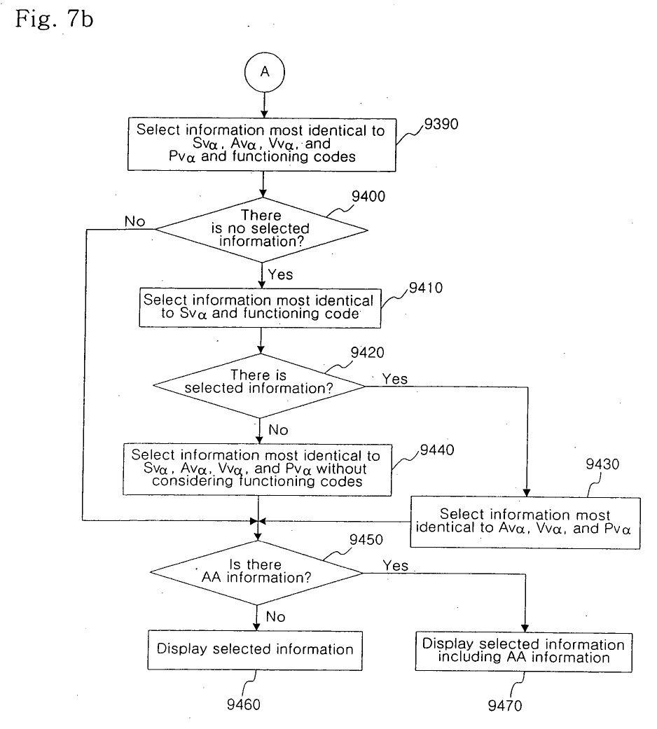

FIG. 7 shows a flowchart illustrating a method for searching information according to functioning codes in a vector space. For example, in a sentence “car(nca) engine(nmamkpo-fstelolor) technology(nkn-iscinan) started(st) in the United States(nus)”, a functioning code can be assigned to each word.

In the sentence, the word “United States” is an adverbial phrase representing a place, the word “technology” functions as a subject word, the words “car” and “engine” function as a modifier, and the word “started” functions as a predicative. When functioning codes are assigned to the sentence, it becomes “car(ncaA) engine(nmamkpo-fstelolorA) technology(nkn-iscinanS) started(stV) in the United States(nusP)”. Here, the “P” indicates the adverbial phrase, the “S” indicates the subject word, the “V” indicates a predicate, and the “A” indicates a modifier.

In addition, in a sentence “car(nca) engine(nmamkpo-fstelolor) technology (nkn-iscinan) started(vst) for the first time(nfi) in the United States(nus) during (nti-obeenan) the First Word War(nwawofi)”, the words “First Word War” and “during” modify an adverb “United States”, the words “car” and “engine” modify the subject word “technology”, and the word “for the first time” modifies the predicate “started”. Accordingly, a functioning code can be assigned to each of the modifiers. That is, a functioning code for modifying the adverb can be “AP”, and a functioning code for modifying the predicate can be “AV”. Therefore, when the functioning codes are assigned to the above sentence, the sentence can be coded as follows:

“car(ncaa) engine(nmamkpo-fstelolorA) technology(nkn-iscinanS) started (vstV) for the first time(nfiAV) in the United States(nusP) during(nti-obeenanAP) the First Word War(nwawofiAP)”.

FIG. 7 shows a flowchart of this embodiment.

When a retrieval command composed of more than two words is input, it is determined if there is a word that is not converted into a word code. When there is a word that is not converted into a word code, the information is searched on the basis of the word (S9300-S9320).

For example, when the retrieval command “life(nliV) of the president(nprS) Clinton(CA) in the White House(nhoofpr-iusP)”, it is more effect to search the information using the word “Clinton” as it is rather than using a word code having a meaning of “the xx^{th} president of the United States”. Therefore, when the retrieval command has name such as “Clinton”, such name is not converted into the word code and used as it is when the information is searched.

The determination if there is a word which is not converted into a word code is realized on the basis of the information stored in the word database. That is, a word list for the words which are not converted into word codes are existed in the database.

Next, when there is a phrase in the retrieval command, the retrieval command is converted into a word code with functioning code assigned to each subject word or each phrase (S9330-S9340). Even when there is no phrase in the retrieval command, the retrieval command is converted into a word code with a functioning code assigned to each word (S9350).

For example, when the retrieval command is “car(ncaA) engine(nmamkpo-fstelolorA) technology(nkn-iscinanS) started(vstV) for the first time(nfiV) in the United States(nusP) during(nti-obeenanAP) the First Word War(nwawofiAP)”, the phrase “the United States during the First Word War” becomes an adverbial phrase. The words of the adverbial phrases are grouped in an identical phrase. This grouping process is called as “sentence analysis”. The sentence analysis is performed using a conventional sentence analysis algorithm.

Next, a vector value is calculated according to functioning codes in a virtual vector space with basic word axis (S9360).

For example, since “the United States during the First Word War” becomes an adverbial phrase, the vector value is calculated after grouping the words of this adverbial phrase as an adverbial phrase. In addition, the “car(ncaA) engine (nmamkpo-fstelolorA) technology(nkn-iscinanS)” is a subject word, the word is also grouped so that the vector value can be calculated on the basis of the grouped one. Likewise, since “started(vstV) for the first time(nfiAV)” is a predicate, the vector value is also calculated after grouping the words.

In addition, when a vector value having a functioning code of the subject words is “Sv”, a vector value having a functioning code of the predicate is “Vv”, and the vector value of the functioning code of the adverbial phrase is “Pv”, angles between each of the vectors according to the functioning code and the basic vector are calculated in the virtual vector space.

Here, the angle between the basic vector and the “Sv” is denoted as Svα, the angle between the basic vector and the “Av” is denoted as Avα, the angle between the basic vector and the “Vv” is denoted as Vvα, and the angle between the basic vector and the “Pv” is denoted as Pvα (S9370-9380).

Next, in the indexing database of the information to be retrieved, the information which is most identical or closest to the angle “Svα, Avα, Vvα, and Pvα” with identical functioning code is selected (S9390).

For example, for the retrieval command “the United States(nusP) during(nti-obeenanAP) the First Word War(nwawofiAP)”, information having a functioning code “P” is selected among a plurality of information which is identical or closest to the Pvα of the retrieval command. In addition, for the retrieval command “car(ncaa) engine(nmamkpo-fstelolorA) technology(nkn-iscinanS)”, information having a functioning code “S” is selected among a plurality of information which is identical or closest to the Svα of the retrieval command. Likewise, for the retrieval command “started(vstV) for the first time(sfiSV)”, information having a functioning code “V” is selected among a plurality of information identical to or closest to the Vvα of the retrieval command.

To enable such selections, the sentences in the information should be classified and each word of the sentence should be classified according to the function when the information to be retrieved is indexed. That is, in the n^{th} sentence in the information having an address “xxxxxx”, the words having the functioning codes “P, S, V, and A” are classified, and the words having an identical functioning code are grouped. The vector value is calculated according to the groups and an angle α between the vector value and the basic vector is calculated. By this approach, the following indexing database is made.

$$\begin{matrix}0.01 ° \text{:} xxxxxxx n P , xxxxxxx n A , xxxxxxxx n S , xxxxxxxx n S , ⋯ \\ 0.02 ° \text{:} xxxxxxx n P , xxxxxxx n S , xxxxxxxx n S , xxxxxxxx n S , ⋯ \\ 0.03 ° \text{:} xxxxxxx n P , xxxxxxx n A , xxxxxxxx n S , xxxxxxxx n V , ⋯ \\ 0.04 ° \text{:} xxxxxxx n P , xxxxxxx n A , xxxxxxxx n P , xxxxxxxx n S , ⋯ \\ 0.05 ° \text{:} xxxxxxx n S , xxxxxxx n A , xxxxxxxx n S , xxxxxxxx n S , ⋯ \\ ⋮ \\ 10.01 ° \text{:} xxxxxx n A , xxxxxx n A , xxxxxxxx n S , xxxxxxxx n S , ⋯ \\ 10.02 ° \text{:} xxxxxx n P , xxxxxx n P , xxxxxxxx n S , xxxxxxxx n S , ⋯ \\ 10.03 ° \text{:} xxxxxx n V , xxxxxx n A , xxxxxxxx n V , xxxxxxxx n S , ⋯ \\ 10.04 ° \text{:} xxxxxx n P , xxxxxx n V , xxxxxxxx n S , xxxxxxxx n S , ⋯\end{matrix}$$

where, each angle is the “α”, “xxxxxxxx” is an address of each information, “n” is the n^{th} sentence in the information, “P, A, S and V” indicates the functioning codes of the words in the sentence.

That is, in the n^{th} sentence of information having an address “xxxxxxx”, the angles of the words having the functioning codes “P, A, S and A” should be stored in the indexing database so as to enable the information to be searched according the process of FIG. 7.

In S9390, when there is no selected information, information having the most identical or closest to the angle of the “Svα” with identical functioning code is selected (S9400-S9410). For example, when considering the above retrieval command, since the words having the subject word code is “car(ncaA) engine(nmamkpo-fstelolorA) technology(nkn-iscinanS)”, information having the angle α identical or closest to the angle Svα between the vector value of the subject word and the basic vector value and having the functioning code of the subject word is searched.

In S9410, when there is anselected information, information having the angle identical or closest to Avα, Vvα, and Pvα from the selected information are selected (S9420-9430). That is, the information closest to the retrieval command is searched with considering the functioning codes.

For example, the information identical or closest to the angle Pvα of the “United States(nusP) during(nti-obeenanAP) the First Word War(nwawofiAP)” and the angle Vvα of “started(vstV) for the first time(nfiSV)” is searched. That is, if there is information having an identical vector value to that of the “United States during the First Word War”, this information is selected even if it does not have the adverbial phrase functioning code. In addition, if there is information having an identical vector value to that of the “started for the first time”, this information is selected even if it does not have the adverbial phrase functioning code.

In S9420, when there is no selected information, information identical or closest to the angles “SVα, Avα, Vvα, and Pvα” are selected without considering the functioning code(S9440).

That is, since the functioning codes are not considered, if there is information having identical or closest angle to that of the vector of “car(ncaA) engine(nmamkpo-fstelolorA) technology(nkn-iscinanS)”, this information is selected even if it does not have the subject word functioning code. Likewise, for other words, the information having an angle identical or closest to that of the vector of the retrieval command.

As described above, the retrieval command is grouped according to its functioning code, the information is searched considering the functioning code, and when there is no information, the information is searched without considering the functioning code, after which it is determined if there is information “AA” (S9450).

The information “AA” is the information which is searched without being converted into the word code.

For example, when the retrieval command is “the life of the president(nprS) Clinton(CA) in the White House(nhoofpr-iusP)”, the word “Clinton” is used as it is without being converted into the word code when the information is searched.

When there is no information “AA”, the information selected through the steps from S9330 to S9440 is output and displayed on the display (S9460). In addition, when there is information “AA”, the information having “AA” along the plurality of information selected through the steps from S9330 to S9440 is displayed on the display (S9470).

That is, when the retrieval command is “the life of the president Clinton in the White House”, information using the word “Clinton” is selected among a plurality of information searched by the word “the life of the president in the White House” through the steps S9330-S9440.

To use the word as it is, an indexing database of the words is required. That is, the frequency of each word of the information should be indexed according to the conventional information database construction method.

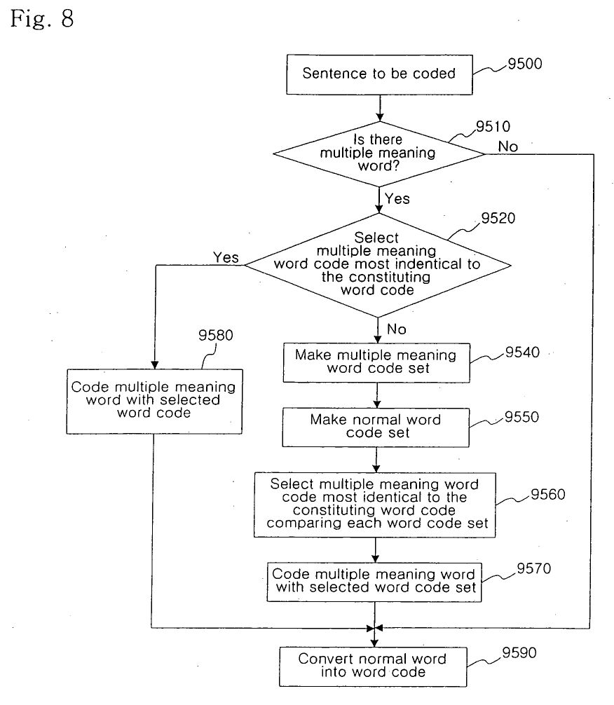

FIG. 8 shows a flowchart for retrieving the information when there is a multiple meaning word.

There is a case that all of the retrieval words and the information to be retrieved should be converted into the word codes. Generally, a word that can be converted into a word code has a corresponding word code in the database, on the basis of which the retrieval word and the information to be retrieved are converted into a word code.

However, when there is a multiple meaning word in the sentence, it is difficult to simply use the word code database to convert the multiple meaning word into a word code. That is, since the multiple meaning word has at least more than two meanings, there may be more than two word codes. Accordingly, it is required to determine the real meaning of the multiple meaning word in the sentence.

When there is a sentence to be converted into word codes, it is first determined if there is a multiple meaning word in the sentence (S9510). That is, it is determined if there is a word having at least two word codes in the sentence.

When there is a multiple meaning word in the sentence, the word codes of the multiple meaning word are compared with a word code of other normal word of the sentence and one of the word codes of the multiple meaning, which is most identical to the word code of other normal word is selected (S9520). The multiple meaning word is coded into the selected word code (S9580).

For example, when it is assumed that a sentence is composed of words having the following word codes,

(22)(11)(101)(501)(60), (88)(90)(77)(58), (55)(44)(33)(22)

The underlines code is a multiple meaning word, and the rest codes are normal words. In addition, the multiple meaning word has another two word codes, such as, “(222)(111)(125)(213)(333)” and (444)(523)(245). Each code in the parenthesis corresponds to one basic word. When each of the basic words is assigned with a numeric, a word code composed of basic words corresponding to the numeric can be considered.

Therefore, the multiple meaning word has three word codes, and the three word codes can be assigned with Nos. 1, 2 and 3, respectively. These three word codes of the multiple meaning word and two word codes of the normal words become the constituting word codes that are compared with each other. The three word codes of the multiple meaning word are compared with the two word codes of the normal words and one of the word codes of the multiple meaning word, which is most identical to the other word codes are selected.

There may be a case where the comparison is impossible. Therefore, a word code set representing basic word codes constituting word codes of the multiple meaning word as other basic word codes is formed (S9540).

For example, when the No. 2 word code of the multiple meaning word is “(222)(111)(125)(213)(333)” and the basic word code “(222)” is “wr” representing “water”, the code “wr” can be represented as another basic word code illustrating the meaning of “water”.

That is, the code “wr” can be represented as another code “Iq=coctsarv”. Likewise, the basic word codes “(111), (125), (213), (333)” can be coded as other basic word codes. Accordingly, the No. 2 multiple meaning word having 5 constituting word codes can be a word code set having 5 word codes. Likewise, each of the Nos. 1 and 3 multiple meaning words can be a word code set having word codes as many as the constituting word codes.

Next, a normal word code set representing basic word codes as other basic word codes is formed (S9550).

The multiple meaning word code sets are compared with the normal word code sets, and one of the multiple meaning word code sets, which is most identical to the normal word code sets is selected (S9560).

For example, a word code set of a No. 1 normal word code “(22)(11)(101)(501)(60)” is “(33)(35)(44)(55), (56)(66)(67)(88)(99), (100)(200)(300) (400), (500)(523)(333)(33), (21)(11)(10)”, and a word code set of a No. 2 normal word code “(55)(44)(33)(22)” is “(123)(455)(43)(22), (66)(76)(17)(99)(33), (211) (100)(320)(80), (56)(23)(133)(13)”.

In addition, a word code set of a No. 1 multiple meaning word code “(88)(90)(77)(58)” is “(33)(55)(34)(55), (66)(166)(7)(58)(109), (20)(523)(133)(23), (11)(51)(610)”, a word code set of a No. 2 multiple meaning word code “(222)(111) (125)(213)(333)” is “(13)(55)(144)(255), (156)(6)(87)(108)(90), (110)(800)(200) (100), (110)(123)(133)(53), (51)(61)(70)”, and a word code set of a No. 3 multiple meaning word code “(444)(523)(245)” is “(23)(55)(100)(66), (76)(106)(74)(89)(90), (105)(220)(23)(140)”.

In the above sets, each of the word code sets has basic word codes as constituting word codes. These constituting word codes are compared with each other, and a word code set having the most identical constituting word codes is selected.

That is, the No. 1 multiple meaning word code set is compared with the normal word code sets to identify the number of identical constituting word codes, the No. 2 multiple meaning word code set is compared with the normal word code sets to identify the number of identical constituting word codes, and the No. n multiple meaning word code set is compared with the normal word code sets to identify the number of identical constituting word codes. One of the multiple meaning word code sets, which has the greatest number of identical constituting word codes, is selected (S9560).

After the comparison, the multiple meaning word is coded as a word code of the selected word code set (S9570). For example, when the word code set of the No. 1 multiple meaning word is selected, the coding step is finished by coding the multiple meaning word as the No. 1 multiple meaning word code.

In addition, the word code set of the multiple meaning word can be compared with word codes of the normal words. That is, only the word code sets for the multiple meaning word is made, the word code sets for the normal words are not made. The word code sets of the multiple meaning word is compared with word codes of the normal words and one of the multiple meaning word code sets which is most identical to the word codes of the normal words is selected.

When the coding of the multiple meaning word is finished, the normal words are coded as word codes (S9590).

The information searching system and method of the present invention can be used for a process control, Internet, and a computer command execution. Here, the control process, Internet and the computer command execution where a sixth embodiment of the present invention is applied will be described hereinafter.

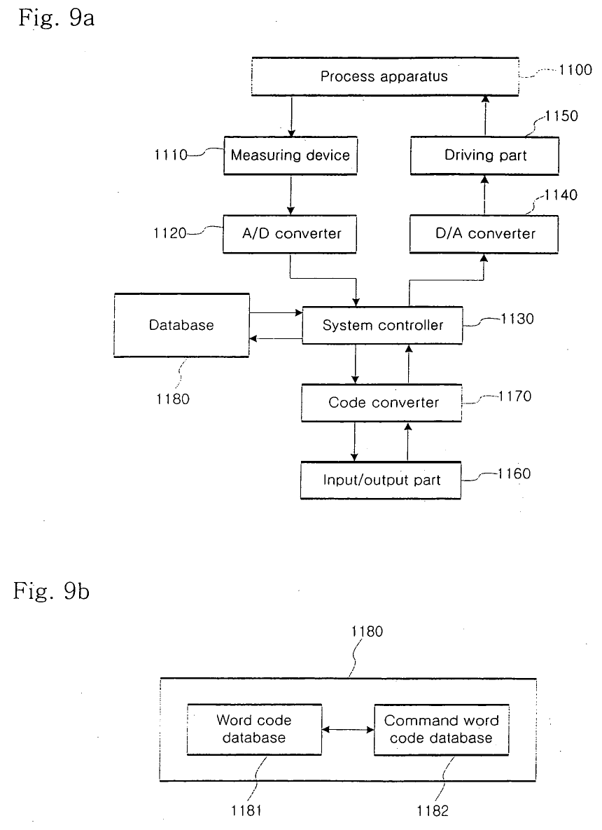

FIG. 9a shows a schematic control block diagram of a process system where a word code is employed.

For example, a process apparatus 1100 for performing the production process is connected to a measuring device 1110 for detecting a temperature, pressure and speed. An analog/digital converter 1120 for converting an analog data output from the measuring device 1110 into a digital data is connected to the measuring device 1110 and a system controller 1130 for controlling the process by processing the input and output data is connected to the analog/digital converter 1120.

The system controller 1130 is connected to a digital/analog converter 1140 for converting the digital data into the analog data. A driving part 1150 for optimizing the process condition of the process apparatus 1100 is connected between the digital/analog converter 1140 and the process apparatus 1100.

An input/output part 1160 having a display part for displaying the process condition and procedure of the process apparatus 1100 and an input part for adjusting the setting point of the process condition is connected to the system controller 1130. The input part can be formed of a keyboard or a touch panel.

A code converter 1170 for converting the words and sentence input from the input/output part 1160 is disposed between the input/output part 1160 and the system controller 1130. The code converter 1170 is actually operated in the system controller 1130, but for the convenience, the code converter 1170 is separately illustrated in the drawing.

FIG. 9b shows a schematic block diagram of a database structure according to this embodiment. As a feature of the present invention, a control database 1180 storing word codes and command word codes is connected to the system controller 1130 to output a command for the process control by comparing the word codes converted by the code converter 1170 with the command word codes.

The database 1180 includes a word code database (referring as “word code list”) 1181 for storing word code information for each process and a command word code database (referring as “command word code list”) 1182 for storing command word codes.

To describe the word code list and the command word code list, a chemical plant is exemplified. Generally, the chemical plant includes plural unit process apparatuses such as a distillation tower, a cooling tower, an absorption tower, a reactor and a mixer. Each of the unit process apparatuses has a proper unit operation. Accordingly, the word codes include a code for representing each unit process apparatus and a code for representing a unit operation corresponding to the unit process apparatus. Since the chemical plant can be regarded as a specific field, the basic words are selected to be proper to the chemical plant.

For example, the word “distillation tower” can be represented as “a tower(tw) for making(mk) gas(gs) from the liquid(lq) or liquid(lq) from the gas(gs)”. Therefore, the word “distillation tower” can be coded as “ntw=mk(gs-flq)(lq-fgs)or”. However, since the “distillation(ds)” is the major unit operation in the chemical plant, the “distillation tower” can be represented as a word code “cindstw” used in the chemical industry field by using the “distillation” as a basic word. Here, the “ci” is a field code representing the chemical industry the “n” is a functioning code representing the noun, and the “dstw” is a code for representing the “distillation tower”.

In addition, in the code “ntw=mk(gs-flq)(lq-fgs)or”, the parentheses means that the code in the parentheses can be illustrated as a unit. That is, the logic “or” means that each of the codes “(gs-flq)” and “(lq-fgs)” can be described as a unit. Other typical processes used in the chemical plant can be also represented as basic word codes used in the chemical industry field. That is, the word code of “cooling tower” performing the cooling(c2) process can be “cinc2tw”, the word code of “reactor(rt)” performing the chemistry reaction process can be “cinrt”, and the word code of the mixer can be “cinmx”.

As described above, the database stores the word code list for each field and the command word code list corresponding to the word code list. Here, although only the chemical plant is exemplified, other process control can employ the word code system of the present invention.

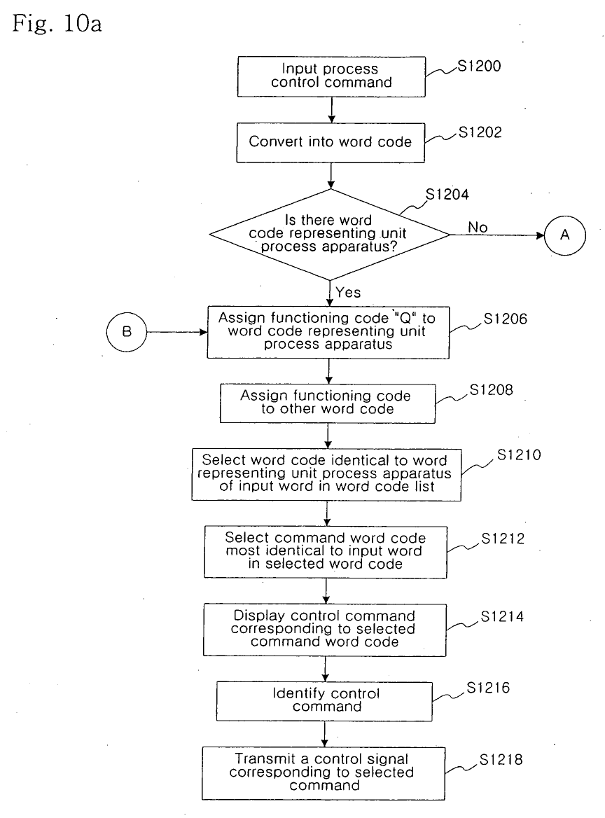

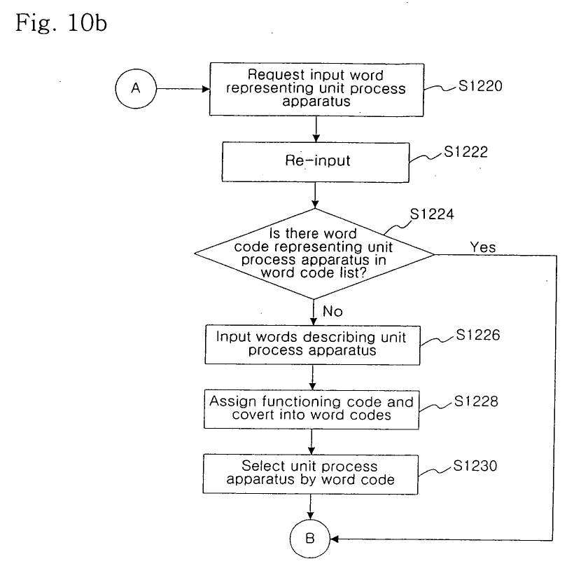

FIG. 10a shows a flowchart of a process control of a process system where the word code of the present invention is applied, showing a method for controlling a temperature of a distillation tower of the chemical plant. Here, it is assumed that the optimum temperature of the process condition is 110° C.

First, when a temperature of the distillation tower is output from the measuring device, the temperature signal is converted into a digital signal by the analog/digital converter, and then transmitted to the system controller. Here, when the present temperature becomes lower than the allowable value, a process for increasing the present temperature of the distillation tower should be performed.

For example, if the present temperature of the distillation tower is 100° C., the operator inputs a control command such as “increase the present temperature of the distillation tower” through the input/output part (key input part) (S1200). This input command is converted into a word code by the code converter(S1202).

Next, the system controller determines if there is a word representing the unit process apparatus in the input word (S1204). That is, since the words representing the unit process apparatuses are stored in the database, it is possible to determine the unit process apparatus corresponding to the input word.

When there is a word representing the unit process apparatus in the database, this word is assigned with a functioning code “Q” (S1206).

That is, since the input control command “distillation tower” represents the unit process apparatus, the command can be coded as “cindstwQ”. The “Q” is the functioning code for identifying the unit process system.

In addition, other words of the input control command are also assigned with the functioning code (S1208). That is, the words “increase the temperature” can be coded having the functioning code such as “nteO vriV”. Therefore, the input control command can be coded as “cindstwQ nteO vriV”.

For the reference, the code “Q” represents the unit process, the “O ” represents the object, and the “V” represents the predicate. The word code “te” means the “temperature and the word code “ri” means the “increase”.

As described above, the conversion into the word code is realized by the association of the program and the word code list according to the predetermined rule.

In input word “distillation tower” is determined as a word meaning the unit process apparatus, being assigned with the functioning code “Q”. This determination is realized by retrieving the word database to search the word meaning the unit process apparatus.

Next, a word code having identical functioning code and word code to the word representing the unit process apparatus of the input command is selected in the word code list in which the word codes related to the process control are stored (S1210).

That is, since the input unit process apparatus is the “distillation tower”, the word code related to the process control command of the distillation tower is selected. Generally, one unit process apparatus has plural process control commands, plural word codes are searched. A word code which is most identical to the input word code is selected among the selected word codes (S1212).

When the command word code is selected, a command word corresponding to the command word code is displayed on the display part to let the operator know the command (S1214).

The operator identifies if the display command is correct, and if correct, finally selects the command (S1216).

A control signal corresponding to the finally selected command is transmitted to the digital/analog converter (S1218), and the driving part is operated to increase the temperature of the distillation tower to the 110° C.

In addition, in S1204, when the input command does not has the word representing the unit process apparatus, the process goes to Step A.

FIG. 10b shows a flowchart illustrating a control process when the word representing the unit process apparatus is not input.

When there is no word representing the unit process apparatus, the operator is required to input the word representing the unit process apparatus (S1220) and the operator inputs new command (S1222). Next, it is determined if there is a word code identical to the word code representing the unit process apparatus in the word code list (S1224). Instead of the input word, the user can input the command in a voice type. In this case, a voice/letter converting device is provided.

Here, when the new command does not have the word representing the unit process apparatus, the operator is required to input a description of the unit process apparatus(S1226). The operator inputs new words related to the unit process apparatus(S1222). Next, It is determined if the word code identical to the word code representing the unit process apparatus is in the word code list (S1224).

Next, the words of the description are coded and assigned with a functioning code (S1228). The unit process apparatus is searched on the basis of the word code and the searched apparatus is selected (S1230).

For example, when the description is “tower for converting liquid into gas”, the words of the description are converted into word codes and a word code which is most identical to the converted word codes is searched. That is, the words of the description can be converted into word codes “IqP gsO mkA twS”. A word code of the unit process apparatus, which is most identical to the word codes, is searched.

At this point, since there are two word codes “ntwk(gs-flq)(lq-fgs)or” and “cindstw”, the word code “ntwk(gs-flq)(lq-fgs)or” is selected.

Here, the unit process apparatus corresponding to the selected word code and the description are displayed on the display part so that the operator can identify whether the correct unit process apparatus is selected.

After the above, the selected word code representing the unit process apparatus is assigned with the functioning code, and other words are also assigned with the functioning code and coded (S1206) so that the temperature control of the distillation tower is realized.

The information searching system of the present invention can be employed to Internet. To this end, the database 13 depicted in FIG. 1 should include a work menu word code database.

Generally, a user has to be in a virtual space where the user can work to obtaining information. That is, the user has to select a work menu on the screen or input a retrieval command.

However, according to the present invention, when the user inputs a description of a desired work space, the desired work space is selected. Accordingly, word code database having word codes corresponding to the work menu should be prepared. This is called as “work menu word code database” in the present invention.

For example, when an Internet user is connected to the homepage of the Patent Office, the user can surf the homepage to, for example, “identify the status of a patent application”, “search U.S. patent”, and “search how to file a patent application”.

Accordingly, to employ the word code system of the present invention, such words should be coded and stored in the work menu word code database. The work menu database is structured in the operating database 132 of FIG. 1.

When the user inputs a retrieval command “status of a patent application”, the user can be connected to a desired work space. The words of the retrieval command are coded into retrieval word codes in accordance with the predetermined rule. A work menu word code which is most identical to the retrieval word codes is selected in the work menu word code list. The work space corresponding to the selected retrieval word codes is provided to the user. For example, since the word “application” means “to give(ge) government (gv) record(re) with respect to the newly(nw) made(mk) thing”, the word code can be “gere=mknw-tgv”. Since the word “patent” means “person(ps) made(mk) new(nw) thing Take(tk) right(rg) from government (gv)”, the word code can be “tkrgps=mknw-fgv”. Since the word “status” means “present(pe) states(st)”, it can be coded as “stpe”. Since the word “method” means “way of doing”, it can be coded as “wydo”. The word “search” can be coded as “sh”.

The command “status of a patent application” can be coded as “ngere=mknw-tgvA ntkrgps=mknw-fgvA nstpeS”. The command “method for file a patent application” can be coded as “ntkrgps=mknw-fgvA ngere=mknw-tgvA nwydoS”. The command “search of U.S. patent” can be coded as “nusA ntkrgps=mknw-fgvA nshS”.

In addition, since the patent is a specific field, the words “patent” and “application” can coded as basic word codes “pm” and “ay”, respectively. Therefore, the command “status of a patent application” can be also coded as “pmnayA pmnpmA nstpeS” in which the code “pm” represents a specific field, and the code “n” represents the noun.

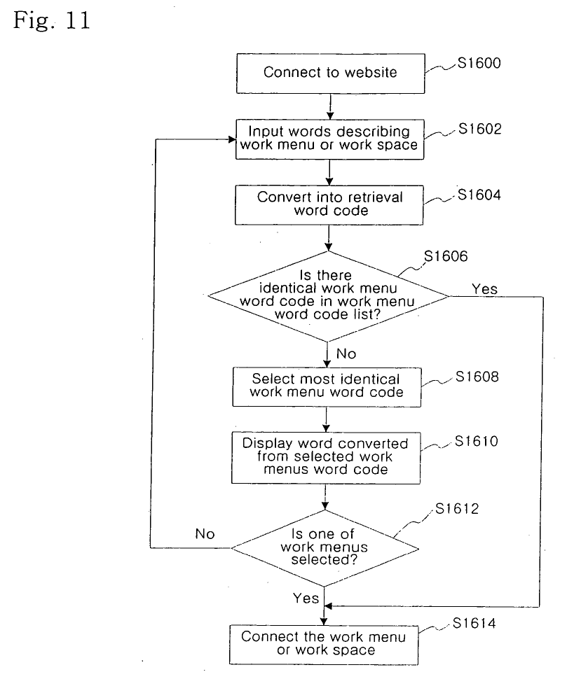

FIG. 11 shows a flowchart illustrating a method for operating a website using an information searching system according to a seventh embodiment of the present invention.

First, the user connects to a website of the Patent Office through Internet (S1600), and then inputs description of a desired work menu or work space through a retrieval window of the homepage of the Patent Office (S1602). The words of the description is coded as retrieval word codes (S1604). For example, when the retrieval words are “status of a patent application”, these are coded as “ngere=mknw-tgvA ntkrgps=mknw-fgvA nstpeS” or “pmnayA pmnpmA nstpeS”.

Next, it is determined if there is a code identical to the retrieval word codes in the work menu word code list (S1606). When there is an identical work menu word code, the work menu or work space corresponding to the code is provided to the user.

When there is no identical retrieval word code, five most identical work menu word codes are selected in the work menu word code list(S1608).

The work menus corresponding to the selected work menu word codes are displayed on the display part (S1610).

The user selects a desired work menu among the work menus (S1612) and a work menu or work space corresponding to the selected work menu is provided to the user (S1614). When there is no desired work menu, a new command is input in Step S1602.

The present invention is also employed for the execution command of a computer. The database includes a program word code database storing word codes of the programs and an execution word code database storing the execution words. In addition, a microprocessor for selecting a program execution word code corresponding to the program word code and executing the selected program is provided.

Generally, a computer program is executed by clicking a menu or an icon on the screen. However, in the present invention, when the user inputs an execution word, the execution word is coded into a word code, and the execution file is searched on the basis of the word code and executed.

Therefore, an execution word code list storing word codes representing the program execution files should be provided in a system of this embodiment. That is, when a specific execution word code is selected in the word code list, an execution file corresponding to the specific execution word code is executed. A program for performing this operation can be made using a program language such as VC++. That is, when a word code which is most identical to the input word code is selected in the list, a program corresponding to the selected word code is executed.

For example, when copying a sentence or a table in the document file, the user inputs a command “copy of chosen sentence and table” through the execution word input window.

Here, the word code of the word “choose” is “ch”. Since the word “sentence” means “message(ms) formed by writing(wt) or(or) printing letters”, it can be coded as “mswtptor”. Since the table means “picture(pc) formed of dot(dt), a line(li) and(an) surface(fa)”, it can be coded as “pc-ffalidtan”. In addition, the word “copy” can be coded as “cp”.

Accordingly, the command “copy of chosen sentence and table” can be coded into a word code “nchA nmswrptorA an npc-ffalidtanA cpS”.

An execution word code which is most identical to the input word code is selected in the execution word code list.

The s elected execution word code is converted into an execution word and displayed on the display part so that the user identifies if the selected execution word is correct. If it is correct, the execution file corresponding to the selected execution word is executed.

Although titles of the word code lists described above are different from each other, the lists are actually similar to each other.

That is, all of the lists are storing word codes made from work commands. At this point, possible execution commands are studied in advance and the possible execution commands are represented as sentences and coded into word codes. For the information that can be pre-stored, the word codes can be expanded to improve the search ability by generically considering the meanings of the retrieval command.

For example, if there is a command “method for filing a patent application” in the pre-stored information, this command can be coded into two word codes “ntkrgps=mknw-fgvA ngere=mknw-tgvA nwydoS” and “pmnpmA pmnayA nwydoS”. Therefore, one work has two word codes.

In addition, the command “method for filing a patent application” can be variously represented as “process for a patent application”, “patent filing method”.

Accordingly, the stored word code expansion can be considered as follows. When the word code for connecting the user to the work space where the user can get the information on the method for filing the patent application is “K21”, the user can goes to the work space by selecting the word code “K21”. Here, the “K21” includes the variety of commends “method for filing a patent application”, “process for a patent application” and “patent filing method”.

For example, the “K21” includes all of the codes “ntkrgps=mknw-fgvA ngere=mknw-tgvA nwydoS” and “pmnpmA pmnayA nwydoS” representing the “method for filing a patent application” and “ntkrgps=mknw-fgvA ngere=mknw-tgvA npcS” representing the command “process for presenting a patent application” and “ntkrgps=mknw-fgvA ngeA nwydoS” representing the command “patent filing method”. Here, the word codes of the words “process” and “presenting” are “pc” and “ge”, respectively.

Accordingly, since the word code “K21” has plural codes that can connect the user to the work space where the user can get the patent filing information, if one of the codes is selected, the user can be connected to the work space.

As described above, to further enhance the retrieval ability, the word code of the stored information can be expanded to more than two. The expansion can be applied to the selection of the execution file of the computer.

The word code of the present invention is also applied to good codes so that the information of the goods can be easily searched. For example, in the field of the Internet commercial transaction, the word codes can be used as standard code of the goods and the parts.

For example, when the word codes of the words “distillation tower”, “engine”, “pump”, and “motor” which are used in the chemical industry are “ntw=mk(gs-flq)(lqfgs) or”, “nmamkpo-fstelolor”, “nma=pomvlqgsor”, and “nmamkmv-fpo”, respectively, these codes can be used as they are for the retrieval and trade of the goods.

Here, the word “pump” has a meaning “moving(mv) machine(ma) for liquid(lq) or gas(gs) using power(po)”, and the word “motor” has a meaning “machine(ma) for making(mk) movement(mv) using electricity(el) power(po)”.

As described above, the word codes of the present invention can be used as meaning code of the goods, thereby making it possible to standardize in searching and trading the goods through the Internet.

While this invention has been described in connection with the most practical and preferred embodiment, it is to be understood that the invention is not limited to the disclosed embodiments, but, on the contrary, it is intended to cover various modifications and equivalent arrangements included within the spirit and scope of the appended claims.

### INDUSTRIAL APPLICABILITY

As described above, in the information searching system and method of the present invention, the information is subdivided and coded as basic word codes. The information is quickly accurately retrieved on the basis of the basic word codes.

In addition, using the concept of the information, the desired information can be easily quickly searched.

TABLE 1

A
ability
about
absence
accident
acid
across
act
actor
add
adjective
admire
adult
advantage
adventure
adverb
advertise
advice
afford
after
afternoon
again
age, n
ago
aim
air, adv
aircraft
airforce
airport
alcohol
all
allow
alone
along
alphabet
already
also
although
always
and
anger, n
angle, n
animal
ankle
answer
ant
any
apparatus
appear
apple
arch, n
area
argue
arm
armour, n
around
art
article
as
ashamed
ash
ask
association
at
atom
aunt
autumn
average, n
avoid
awkward
B
baby
back, adj
bateria
bad
bag, n
bake
balance
ball
banana
band, n
bank, n
bar, n
bare, adj
base, n
basket
be
beam, n
bean
bear
beauty
because
become
bed, n
bee
beer
before
beg
begin
believe
bell
belong
bend
berry
between
beyond, adv
bicyle, n
big, adj
bill, n
bind, v
bio, n
bird
birth
birthday
bit
black, adj
blade
bless
blind
blood, n
blue
boat, n
body
boil, v
bomb
bone, n
book, n
border
born
bottle, n
bowl, n
box, n
boy
brain, n
brass
brave, adj
bread
breakfast, n
breast, n
breath
brick, n
bridge, n
bright, adj
bring
broadcast
brother
brown, adj
building
bullet
burst
bus, n
bush, n
business
busy
but
butter, n
button, n
buy, v
by
C
cake, n
caculate
call
calm. adj
camera
camp, n
can, v, n
candle
cap, n
capital, n
captain, n
car
card, n
case, n
cat
catch, v
cattle
cause
C.D.
cell
cellular phone
cement, n
cent
centimeter
center, n
century
ceremony
chain
chair, n
chalk, n
chance, n
charge
chase, v
cheek, n
cheese
chemistry
chest
chicken, n
chief
child
chin
chocolate
choose
church
cigarette
cinema
circle, n
city
claim
class
clay
clear, n
clock, n
close, adj
cloth
cloud, n
coal
coast, n
coffee
coin, n
cold
collage
color
come
comfort
common, adj
communication
company
compete
complete
computer
concern, n
confuse
conscious
contain
continue
control
cook
cool, adj
copper
copy
cord, n
corn
cotton
cough
council
count, n
course, n
court, n
cover
coward
crack, n
cream, n
creature
cricket
crime
crop, n
cross, n
cry
cup, n
curtain, n
curve
custom, n
cut
cycle, v
D
dance
dark
daughter
day
dead, adj
deal, n
deceive
declare
decorate
decrease
deep, adj
deer
defence
degree
delicate
desert, n
deserve
desk
destroy
diamond
dictionary
difference
difficult
dig, n
dirt
discover
dish, n
distance, n
ditch, n
divide, v
DNA
do, v
doctor, n
dog, n
dollar
door
dot, n
doubt
down, adj
drag, v
draw, v
dream
dress, v
drink, n, v
drive, v
drug, n
drum, n
dry
duck, n
dull
during
E
each
ear
early
earth, n
east
easy
eat
economy
edge, n
egg, n
eight
either
elastic
elbow. n
electric
electronic
elephant
else
employ, v
empty, adj
end
enemy
engine
engineer, n
English
enjoy
entertainment
escape
even, adj
evening
event
ever
every
evil
examine
example
except
exist
expect
explain
eye
F
face
fact
factory
fail
fair, adj
faith
fall
false, adj
familiar, adj
family
farm
fashion, n
fat
fate
father, n
favour, n
fear
feather, n
feel, v
fellow, n
female
fever
few
fifth
fight
fill, n
film
find, v
fine, adj
finger, n
fire
first, adj
fish
fit, v
five
fix, v
flag, n
flat
flesh
floor, n
flour
flow
flower, n
fly, n, v
fold
food
fool, n
foot, n
football
for
foreign
forest
forgive
fork, n
form
four
fox, n
frame, n
free
freeze, v
fresh
friend
from
fruit, n
fulfil
full, adj
fun
fur, n
furniture
future
G
gain, v
game, n
garage, n
garden
gas, n
gate, n
general
gene
germ
get
gift
girl
give, v
glass, n
glory, n
go, v
goat
God
gold
good
goodbye
government
grace
grain
gram
grammar
grass, n
green
grey, n
grief
ground, n
group, n
grow
guard
guess
guest
gun, n
H
hair
half
hand
handle
happen, v
happy
hard
hat
have
he
head, n
health
hear
heart
heat
heaven
heavy, adj
help
her
here
hide, v
high, adj
history
hit
hold
holiday
holy
home, n
honest
hope
horse, n
hospital
host, n
hot, adj
hotel
hour
house, n
how
human
hundred
I
I
ice, n
idea
if
ill, adj
imagine
in
industry
ink, n
insect
inside
intend
interest
internet
iron, n
island
it
J
jewel
job
join
joke
judge
juice
jump
K
keep, v
key, n
kilo
kind
king
kingdom
kiss
knee, n
knife, n
know, v
L
land
language
large
last, adj
late
laugh
law
lead, v
leaf, n
learn
leather
leave, v
leg, n
level, adj
library
lie
life
lift
light
like, v
limit
line, n
lion
lip
liquid
list, n
liter
little
live, v
local, adj
lock
long, adj
look
love
low, adj
luck, n
lump, n
lung
M
machine, n
mad
magazine
magic
mail
make, v
male
man, n
manage
many
map, n
mark
market, n
marry
material
may, v
measure
meat
medicine
meet, v
member
memory
message
metal
meter
microscope
middle, n
mile
milk
million(th)
mind
mineral
minute, n
mistake
mix, v
model, n
money
monkey
month
moon
moral, adj
morning
most
mother, n
motor, n
mountain
mouse
mouth. n
move, v
much
mud
multiply
muscle
music
must, v
N
nail
name
narrow, adj
nation
nature
navy
near, adj
neck
need
needle, n
nerve, n
nest, n
net, n
network, n
new
news
newspaper
next, adj
night
nine
no
noise, n
north
nose, n
not
noun
now
number, n
nurse
nut
nylon
O
object, n
ocean
odd
of
official
often
oil
old
on
one
onion
only
open, v
opinion
or
orange
order
organ
origin
other
out
over
oxygen
P
pack, v
page, n
pain, n
pair, n
paper, n
parallel, adj
parent, n
parliament
part, n
party, n
past
peace
pen, n
pencil, n
people, n
pepper, n
per
person
pet, n, v
photography
physics
piano, n
picture, n
pig, n
pilot
pink, n
place
plan
plane, n
plant
plastic
plate. n
play
plural
poem
poison
police, n
polite
politics
poor
population
port, n
potato
pound, n
powder, n
power, n
pray
prepare
present, n, adj
president
press, v
prevent
price, n
prince
print
private, adj
prize, n
problem
process, n
produce, v
profession
program
proof, n
proud
public
pull
pump
punish
pure
purple
push
put
Q
quality
quantity
quarter, n
queen, n
question
quick, adj
R
rabbit, n
radio, n
rain
rare
rat, n
rate, n
rather
raw, adj
read, v
ready, adj
real
recent
record, n
recoder
red
regular, adj
relation
religion
remain
remove, v
repair
repeat, v
republic
respect
rest
restaurant
result
return, v
reward
rice
rich
ride
right, adj
ring
ripe
rise, v
river
road
rock, n
roll, v
roof, n
room, n
root, n
rose
rough, adj
rub, v
rule
run
S
safe, adj
sail
salt, n
same
sand, n
satisfy
save, v
say, v
school, n
science
screw
sea
search
season, n
seat
second
see, v
seed, n
sell, v
send
sense, n
separate, adj
serious
servant, n
service, n
set, n
seven(th)
severe
sew
sex, n
shade
shame, n
share
sharp, adj
she
sheep
sheet
shelf
shine, n
ship, n
shirt
shock, n
shoe, n
shoot, v
shop
shore, n
short, adj
shoulder
show, n, v
side, adj
signal
signature
silence, n
silk
silver
simple
since
sing
sink, v
sister
sit
six(th)
size, n
skill
skin, n
skirt, n
sky, n
sleep, v
slide
slope
slow
small
smell
smoke
smooth, adj
snake, n
snow
so
soap, n
society
soil, n
soldier, n
solid
some
son
sorrow, n
sort, n
soul
sound, n
soup
sour, adj
south
space, n
special
speech
speed, n
spell
spend
spin, v
spoil, v
spoon, n
sport, n
spread, v
spring
square, adj
stage, n
stamp
stand, v
standard
star, n
start
station, n
stay
steady, adj
steal, v
steam, n
steel, n
step
stiff, adj
stocks
stomach, n
stone, n
stop
store, n
storm, n
story
straight, adj
strange
street
stretch
structure, n
student
study
success
suck, v
sugar, n
sum, n
summer, n
sun, n
supper
support
sure, adj
surface, n
sweet
swell, v
swim
swing
sword
sympathy
system
T
table, n
tail, n
tall
taste
tax
taxi, n
tea
teach
team, n
tear, n, v
telephone
television
temperature
temple
tend
tennis
tent
test
than
thank
that
the
theater
them
there
they
thick, adj
thin, adj
thing
think, n
thirst, n
this
though
thousand(th)
thread, n
three
throat
through
throw
thunder
ticket, n
tie
tiger
time, n
timetable, n
tin
tire, v
title
to
tobacco
today
toe, n
together
tomorrow
tongue
tool. n
tooth
top, n
total, adj
touch
tour
tower, n
town
toy, n
traffic, n
train
translate
tree
trick, n
tropical
trousers
try
twice
twist
tyre
U
under
uniform, n
union
universe
university
up
upper
urgent
USA
use
usual
V
value, n
vegetable
vehicle
verb
very, adj
view, n
village
visit
virus
voice, n
vote
W
wages
waist
waiter
wake, v
walk
wall, n
wander
want, v
war, n
warm, adj
waste
watch
water
way
we
weak
weapon
wear, v
weather, n
weave, v
week
welcome
west
wet, adj
what
wheat
wheel, n
when
where
whether
which
while
white
who
whole
why
wide, adj
width
wife
wild, adj
will
win, v
wind
wind, n, v
window
wine, n
wing, n
winter, n
wire, n
wise, adj
with
witness, n
woman
wood
wool
word, n
work
world
worm, n
worry
worship
worthy
wound
wreck
wrist
write
wrong, adj
Y
yard
year
yellow, adj
yes
yesterday
yet
you
young

1. An information searching system comprising:
an input part for inputting retrieval words representing information;
a database for storing word codes formed by coding words representing the information, each of the word codes being assigned with a functioning code representing its function in the information; and
a processor for coding the retrieval words into basic word codes each having a functioning code and retrieving the database on the basis of the basic word codes to search the information having identical functioning and word codes to the basic word codes,
wherein the search of information having the identical or most similar word codes is performed separately from the search of information having the identical or most similar functioning codes.

2. An information searching system of claim 1 wherein when the retrieval command includes a phrase, each of the words of the command is assigned with the functioning code such that its functions in the command and the phrase can be discriminated from each other.

3. An information searching system of claim 1 wherein when the retrieval command is formed of at least two sentences, each of the words of the sentences is assigned with the functioning code such that the sentences can be discriminated from each other.

4. An information searching system of claim 1 wherein when there is no information having the identical functioning and word codes, the processor searches information which is identical to the functioning code, and is most similar to the basic word code.

5. A method for searching information, comprising the steps of:
determining if input retrieval command is formed of plural words;
coding each of the words into a basic word codes with a functioning code; and
retrieving a database storing word codes formed by coding words representing the information on the basis of the basic word codes to search the information having identical functioning and word codes to the basic word codes.

6. A method for searching information of claim 5 wherein the step of retrieving further comprising the steps of:
selecting information which is most identical to the functioning and word codes of the words of the retrieval command except for a subject word of the retrieval command; and
searching information having a word code modified by the selected information and most identical to the subject word.

7. A method for searching information of claim 5 wherein when there are more than two words having an identical functioning code in the words of the retrieval command, the words having the identical functioning code are grouped and information having the identical functioning code and the most identical word codes is searched.

8. A method for searching information of claim 5 wherein the step of retrieving further comprises the step of searching information which is identical to a subject word code of the retrieval command and most identical to the rest word codes of the retrieval command.

9. A method for searching information comprising the steps of:
storing word codes of words representing information in a database;
coding words of a retrieval command into basic word codes according to a predetermined rule; and
searching information which is most identical to the basic word codes by retrieving the database,
wherein the word code of the retrieval command is extended to more than two word codes.

10. A method of claim 9 wherein when there is a word code of a lower level of the retrieval command not including a retrieval word code, the searching is performing on the basis of a lower level word code not including the retrieval word code.

11. A method of claim 9 wherein when the word of the retrieval command is a basic word, the word is coded as a new code formed by other basic words describing the word of the retrieval command, and the searching is performed on the basis of the new code.

12. A method of claim 9 wherein when coding the words representing the information and the words of the retrieval command, each of the words is coded including a property of the word as a constituting word code.

13. A method of claim 9 wherein when there is a word, which is not coded, among the words of the retrieval command, information including the word which is not coded is searched.

14. A method for searching information comprising the steps of:
storing word codes of words representing information in a database;
coding words of a retrieval command into basic word codes according to a predetermined rule; and
searching information which is most identical to the basic word codes by retrieving the database,
wherein the information to be retrieved is represented as a vector value in a vector space having axe formed by basic word;
an angle α between a basic vector and an information vector to be retrieved, is calculated and
an indexing database of the information according to the calculated angle is made.

15. A method of claim 14 wherein the words of the retrieval command are converted into a vector value, an angle Sα between the basic vector and the retrieval word vector is calculated, and the information is searched on the basis of the calculated angle Sα through the indexing database.

16. A method of claim 14 wherein a vector value of the retrieval word according to the functioning code is calculated in the vector space, an angle between the vector value and the basic vector is calculated, and the information is searched considering the functioning code.

17. A method of claim 14 wherein a vector value of the retrieval word according to the functioning code is calculated in the vector space, an angle between the vector value and the basic vector is calculated, and the information is searched without considering the functioning code.

18. A method of claim 9 wherein if there is a multiple meaning word in the words of the retrieval command or the information to be retrieved, word code sets representing basic word codes constituting word code of the multiple meaning word as other basic word codes are formed, and the word code sets are compared with normal word codes.

19. (canceled)

20. (canceled)

21. (canceled)

22. (canceled)

23. (canceled)

24. (canceled)

25. (canceled)

26. (canceled)

27. A method of claim 14 wherein if there is a multiple meaning word in the words of the retrieval command or the information to be retrieved, word code sets representing basic word codes constituting word code of the multiple meaning word as other basic word codes are formed, and the word code sets are compared with normal word codes.
